(19) United States
(12) Patent Application Publication
(10) Pub. No.: US 2025/0314893 A1
(43) Pub. Date: Oct. 9, 2025

(54) IMAGE GENERATION DEVICE AND HEAD-MOUNTED DISPLAY

(71) Applicant: Panasonic Intellectual Property Management Co., Ltd., Osaka (JP)

(72) Inventors: Mitsuyoshi MORI, Kyoto (JP); Hiroyuki FURUYA, Osaka (JP)

(73) Assignee: Panasonic Intellectual Property Management Co., Ltd., Osaka (JP)

(21) Appl. No.: 19/244,975

(22) Filed: Jun. 20, 2025

Related U.S. Application Data
(63) Continuation of application No. PCT/JP2023/043069, filed on Dec. 1, 2023.

(30) Foreign Application Priority Data
Jan. 5, 2023 (JP) 2023-000741

(51) Int. Cl. G02B 27/01

(52) U.S. Cl. CPC G02B 27/0172; G02B 27/0179; G02B 2027/0138; G02B 2027/014; G02B 2027/0147; G02B 2027/0187

(57) ABSTRACT

An image generation device includes: an imaging processor including a camera configured to capture an image over a range of a field of view, the imaging processor being configured to output a first captured video signal for forming a frame image having a first definition and a second captured video signal for forming a frame image having a second definition; a first frame buffer configured to store the first captured video signal; and a second frame buffer configured to store the second captured video signal. To a first image region, the first captured video signal from the first frame buffer is applied, whereby an image is generated, and to a second image region, the second captured video signal from the second frame buffer is applied, whereby an image is generated.

### CROSS REFERENCE TO RELATED APPLICATION

This application is a continuation of International Application No. PCT/JP2023/043069 filed on Dec. 1, 2023, entitled “IMAGE GENERATION DEVICE AND HEAD-MOUNTED DISPLAY”, which claims priority under 35 U.S.C. Section 119 of Japanese Patent Application No. 2023-000741 filed on Jan. 5, 2023, entitled “IMAGE GENERATION DEVICE AND HEAD-MOUNTED DISPLAY”. The disclosures of the above applications are incorporated herein by reference.

### BACKGROUND OF THE INVENTION

### Field of the Invention

The present invention relates to an image generation device and a head-mounted display that generate an image by performing scanning with light.

### Description of Related Art

To date, as an image generation device that generates an image by performing scanning with light, a head-mounted display, such as goggles and glasses, that realizes AR (Augmented Reality) or VR (Virtual Reality) has been known, for example. In these devices, for example, light based on a video signal is applied toward a translucent display, and the reflected light is applied to the eyes of a user.

Alternatively, light based on the video signal is directly applied to the eyes of the user.

U.S. Pat. No. 9,986,215 describes a device that, by controlling rotation of a fast axis and a slow axis of an MEMS mirror, realizes a first linear density in a first portion of an image and realizes a second linear density lower than the first linear density in a second portion of the image, thereby determining the position of the first portion of the image, based on the line of sight of eyes. Accordingly, the resolution of the image in the second portion not corresponding to the line of sight becomes lower than the resolution of the image in the first portion corresponding to the line of sight, and thus, the eyes of the user are less likely to become tired.

In the head-mounted display as above, as a video signal for modulating light for image generation, a video signal obtained by capturing an image of the area in front of the user can be used, for example. Accordingly, even if the above-described goggles and glasses are not particularly see-through, the user can grasp the scenery in front from the captured image.

In this case, in order to enable the user to more comfortably see the image, it is preferable that the definition of the image in the portion corresponding to the line of sight of the user and the definition of the image in the other portion are made different from each other.

However, since the line of sight of the user can dynamically change, if a video signal having each definition is generated in accordance with the line of sight, the video signal cannot be generated in time, and delay in display may occur. When such delay in display occurs, the image is distorted, which may result in discomfort for the user.

### SUMMARY OF THE INVENTION

An image generation device according to a first aspect of the present invention includes: an imaging processor including a camera configured to capture an image over a range of a field of view, the imaging processor being configured to output a first captured video signal for forming a frame image having a first definition and a second captured video signal for forming a frame image having a second definition different from the first definition; a first frame buffer configured to store the first captured video signal; a second frame buffer configured to store the second captured video signal; a light source configured to emit light for forming the frame image; a scanner configured to perform scanning with the light emitted from the light source; a detector configured to detect a line of sight of a user; and a controller. The controller: controls the light source and the scanner such that, to a first image region including a viewpoint position on the frame image corresponding to the line of sight, the first captured video signal from the first frame buffer is applied, whereby an image is generated; and controls the light source and the scanner such that, to a second image region other than the first image region of the frame image, the second captured video signal from the second frame buffer is applied, whereby an image is generated.

In the image generation device according to the present aspect, the first captured video signal stored in the first frame buffer and the second captured video signal stored in the second frame buffer are selectively used in accordance with the line of sight of the user, whereby an image for one frame is generated. Therefore, the definition of the image can be smoothly switched between the first image region near the line of sight of the user and the other second image region.

A head-mounted display according to a second aspect of the present invention comprises: the image generation device according to the first aspect; a frame configured to hold the image generation device; and an optical system configured to guide light from the image generation device, to an eye of the user wearing the head-mounted display on a head of the user.

In the head-mounted display according to the present aspect, effects similar to those in the first aspect are exhibited. By wearing the head-mounted display on the head, the user can grasp the scenery, etc. of which an image is captured by the camera, through the frame image generated by the image generation device.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1 is a perspective view schematically showing a configuration of AR glasses according to Embodiment 1;

FIG. 2 schematically shows a configuration of a projector according to Embodiment 1;

FIG. 3 is a block diagram showing configurations of the projector and a detector according to Embodiment 1;

FIG. 4 is a block diagram showing a configuration of a signal processor according to Embodiment 1;

FIG. 5 schematically shows first and second captured video signals acquired by a camera according to Embodiment 1;

FIG. 6 is a schematic diagram for describing a thinning process performed by an input processor according to Embodiment 1;

FIG. 7A schematically shows generation of a frame image according to a comparative example;

FIG. 7B schematically shows generation of a frame image according to Embodiment 1;

FIG. 8 is a flowchart showing a generation process of the frame image performed by an image generation device according to Embodiment 1;

FIG. 9 is a flowchart showing details of a storing process according to Embodiment 1;

FIG. 10 is a block diagram showing a configuration of the signal processor according to Modification 1 of Embodiment 1;

FIG. 11 is a schematic diagram for describing a thinning process performed by an input processor according to Modification 1 of Embodiment 1;

FIG. 12 is a block diagram showing a configuration of the signal processor according to Modification 2 of Embodiment 1;

FIG. 13 schematically shows that a first image region is set to one of five regions, based on a viewpoint position according to Modification 3 of Embodiment 1;

FIG. 14 shows the scanning speed of a second mirror when five regions are each set as the first image region according to Modification 3 of Embodiment 1;

FIG. 15 is a block diagram showing a configuration of the signal processor according to Embodiment 2;

FIG. 16 schematically shows a first captured video signal and a second captured video signal acquired by the camera when a first exposure time is longer than a second exposure time according to Embodiment 2;

FIG. 17A to FIG. 17D schematically show video signals stored in two first buffers and two second buffers when the first exposure time is longer than the second exposure time according to Embodiment 2;

FIG. 18A schematically shows generation of the frame image when the first exposure time is longer than the second exposure time according to Embodiment 2;

FIG. 18B is a diagram showing an example of the frame image when the first exposure time is longer than the second exposure time according to Embodiment 2;

FIG. 19 schematically shows the first captured video signal and the second captured video signal acquired by the camera when the first exposure time is shorter than the second exposure time according to Embodiment 2;

FIG. 20A to FIG. 20D schematically show video signals stored in two first buffers and two second buffers when the first exposure time is shorter than the second exposure time according to Embodiment 2;

FIG. 21A schematically shows generation of the frame image when the first exposure time is shorter than the second exposure time according to Embodiment 2;

FIG. 21B is a diagram showing an example of the frame image when the first exposure time is shorter than the second exposure time according to Embodiment 2;

FIG. 22 is a flowchart showing a generation process of the frame image performed by the image generation device according to Embodiment 2;

FIG. 23 is a block diagram showing a configuration of the signal processor according to Embodiment 3;

FIG. 24A schematically shows generation of the frame image according to Embodiment 3;

FIG. 24B is a diagram showing an example of the frame image according to Embodiment 3; and

FIG. 25 is a block diagram showing a configuration of the signal processor according to another modification.

It is noted that the drawings are solely for description and do not limit the scope of the present invention in any way.

### DETAILED DESCRIPTION

Hereinafter, embodiments of the present invention will be described with reference to the drawings. In the embodiments below, an example in which the present invention is applied to an image generation device for a head-mounted display is shown. Examples of the head-mounted display include AR glasses, AR goggles, VR glasses, VR goggles, and the like. The head-mounted display in the embodiments below is AR glasses. However, the embodiments below are examples of embodiments of the present invention, and the present invention is not limited to the embodiments below in any way. For example, not limited to an image generation device for a head-mounted display, the present invention is also applicable to an image generation device for a vehicle-mounted head-up display, and the like.

### Embodiment 1

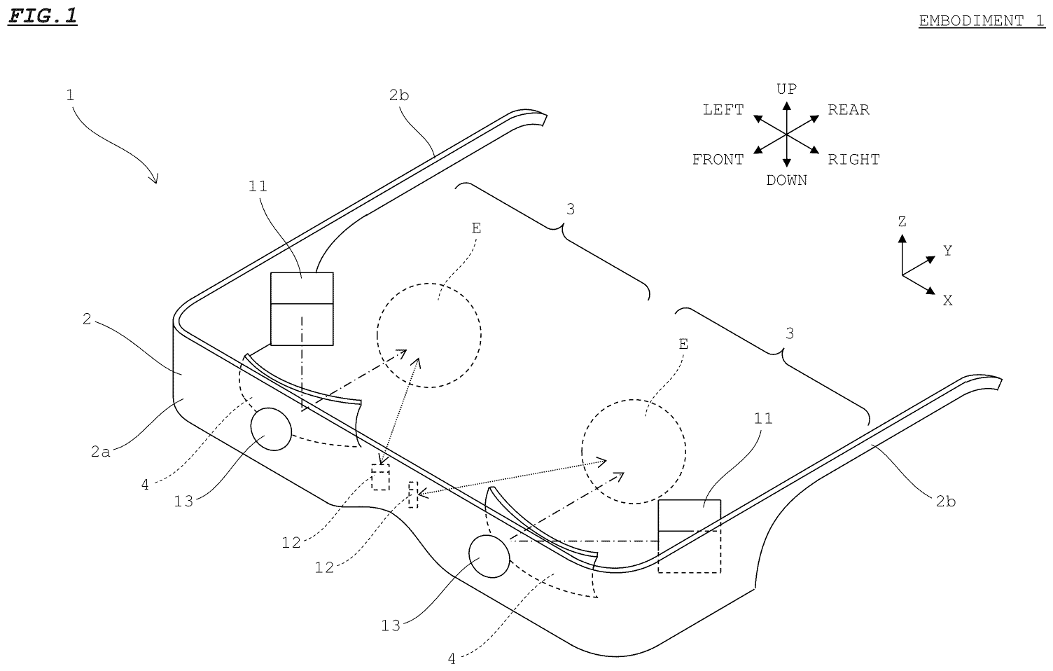

FIG. 1 is a perspective view schematically showing a configuration of AR glasses 1.

In FIG. 1, front, rear, left, right, up, and down directions of the AR glasses 1 and X, Y, and Z-axes orthogonal to each other are indicated. The X-axis positive direction, the Y-axis positive direction, and the Z-axis positive direction correspond to the right direction, the rear direction, and the up direction of the AR glasses 1, respectively.

The AR glasses 1 include a frame 2, a pair of image generation devices 3, and a pair of mirrors 4. Similar to typical eyeglasses, the AR glasses 1 are worn on the head of a user.

The frame 2 holds the pair of image generation devices 3 and the pair of mirrors 4. The frame 2 is composed of a front face part 2a and a pair of support parts 2b. The pair of support parts 2b extend rearward from the right end and the left end of the front face part 2a. When the frame 2 is worn by the user, the front face part 2a is positioned in front of a pair of eyes E of the user. The frame 2 is formed from an opaque material. The frame 2 may be formed from a transparent material.

The pair of image generation devices 3 is in line symmetry with each other with respect to a Y-Z plane passing through the center of the AR glasses 1. Each image generation device 3 generates an image at the eye E of the user having the AR glasses 1 worn on his or her head.

Each mirror 4 is a mirror whose reflection surface is formed in a concave shape, and is installed on the inner face of the front face part 2a of the frame 2. The mirror 4 substantially totally reflects light projected from a corresponding projector 11, to guide the light to the eye E of the user.

Each image generation device 3 includes a projector 11, a detector 12, and a camera 13.

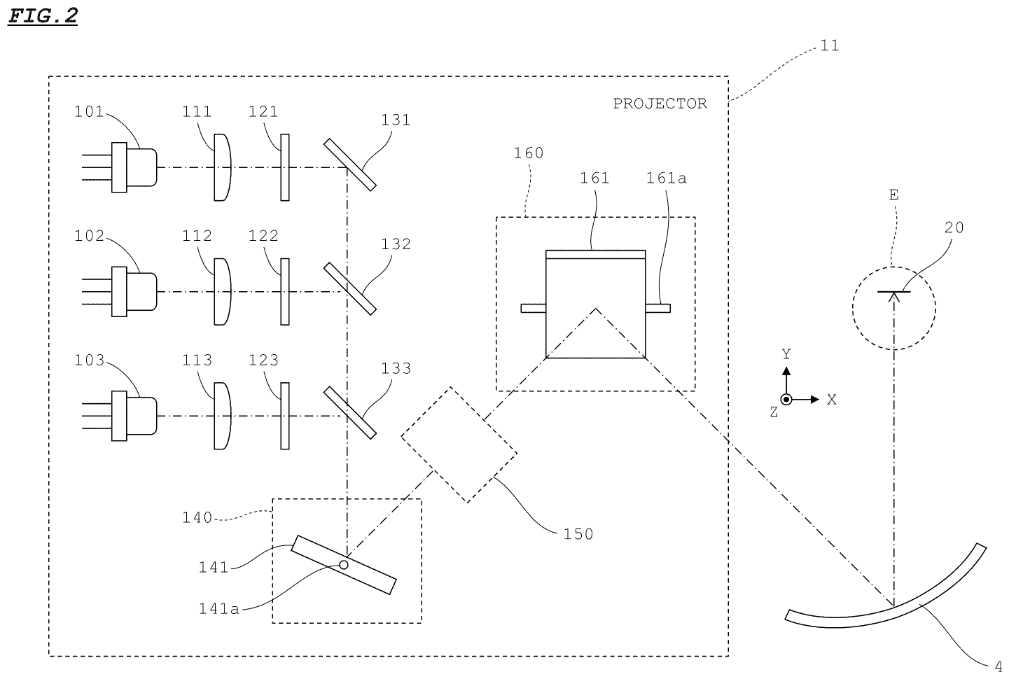

The projector 11 is installed on the inner face of each support part 2b. The projector 11 projects light modulated by a video signal, to a corresponding mirror 4. The light from the projector 11 reflected by the mirror 4 is applied to the central fossa positioned at the center of the retina in the eye E. Accordingly, the user can visually grasp a frame image 20 (see FIG. 2) generated by the image generation device 3.

The pair of detectors 12 are installed on the inner face of the front face part 2a, between the pair of mirrors 4. Each detector 12 is used in order to detect the line of sight of the user.

The pair of cameras 13 are installed on the outer face of the front face part 2a, in front of the pair of mirrors 4. Each camera 13 captures an image over the range of the field of view of the camera 13. The range of the field of view of the camera 13 of the present embodiment is the area in front of the AR glasses 1.

FIG. 2 schematically shows a configuration of the projector 11.

The projector 11 includes light sources 101, 102, 103, collimator lenses 111, 112, 113, apertures 121, 122, 123, a mirror 131, dichroic mirrors 132, 133, a first scanner 140, a relay optical system 150, and a second scanner 160.

The light sources 101, 102, 103 are each a semiconductor laser light source, for example. The light source 101 emits laser light having a red wavelength included in a range of 635 nm or more and 645 nm or less, the light source 102 emits laser light having a green wavelength included in a range of 510 nm or more and 530 nm or less, and the light source 103 emits laser light having a blue wavelength included in a range of 440 nm or more and 460 nm or less.

In Embodiment 1, a color image is generated as the frame image 20 described later, and thus, the projector 11 includes the light sources 101, 102, 103 that can emit red, green, and blue laser lights. When an image in a single color is displayed as the frame image 20, the projector 11 may include only one light source that corresponds to the color of the image. The projector 11 may be configured to include two light sources whose emission wavelengths are different from each other.

The lights emitted from the light sources 101, 102, 103 are converted into collimated lights by the collimator lenses 111, 112, 113, respectively. The lights having passed through the collimator lenses 111, 112, 113 are shaped into approximately circular beams by the apertures 121, 122, 123, respectively.

The mirror 131 substantially totally reflects the red light having passed through the aperture 121. The dichroic mirror 132 reflects the green light having passed through the aperture 122, and transmits therethrough the red light reflected by the mirror 131. The dichroic mirror 133 reflects the blue light having passed through the aperture 123, and transmits therethrough the red light and the green light having advanced via the dichroic mirror 132. The mirror 131 and the two dichroic mirrors 132, 133 are placed such that the optical axes of the lights in the respective colors emitted from the light sources 101, 102, 103 are caused to coincide with each other.

The first scanner 140 reflects the lights having advanced via the dichroic mirror 133. The first scanner 140 is an MEMS (Micro Electro Mechanical System) mirror, for example. The first scanner 140 is provided with a configuration that causes a first mirror 141 on which the lights having advanced via the dichroic mirror 133 are incident, to rotate about an axis 141a, which is parallel to the Z-axis direction, in accordance with a driving signal. Through rotation of the first mirror 141, the light reflection direction changes. Accordingly, the lights reflected by the first mirror 141 are scanned along a scanning line extending in the X-axis direction on the retina of the eye E as described later.

The relay optical system 150 directs the lights reflected by the first scanner 140 toward the center of a second mirror 161 of the second scanner 160. That is, the lights incident on the first scanner 140 are deflected at a predetermined deflection angle by the first mirror 141. The relay optical system 150 directs each light at the deflection angle, toward the center of the second mirror 161. The relay optical system 150 has a plurality of mirrors, and causes the plurality of mirrors to reflect the lights reflected by the first scanner 140, toward the second scanner 160. Accordingly, a long optical path length can be realized inside the relay optical system 150, and the deflection angle of each light when viewed from the second mirror 161 can be suppressed.

The second scanner 160 reflects the lights having advanced via the relay optical system 150. The second scanner 160 is an MEMS mirror, for example. The second scanner 160 includes a configuration that causes the second mirror 161 on which the lights having advanced via the relay optical system 150 are incident, to rotate about an axis 161a, which is parallel to an X-Y plane, in accordance with a driving signal. Through rotation of the second mirror 161, the light reflection direction changes. Accordingly, on the retina of the eye E, the scanning line caused by the first scanner 140 performing scanning with light is changed in the Z-axis direction as described later.

The lights reflected by the second scanner 160, i.e., the light emitted from the projector 11, are reflected by the mirror 4 to form a frame image 20 on the retina of the eye E.

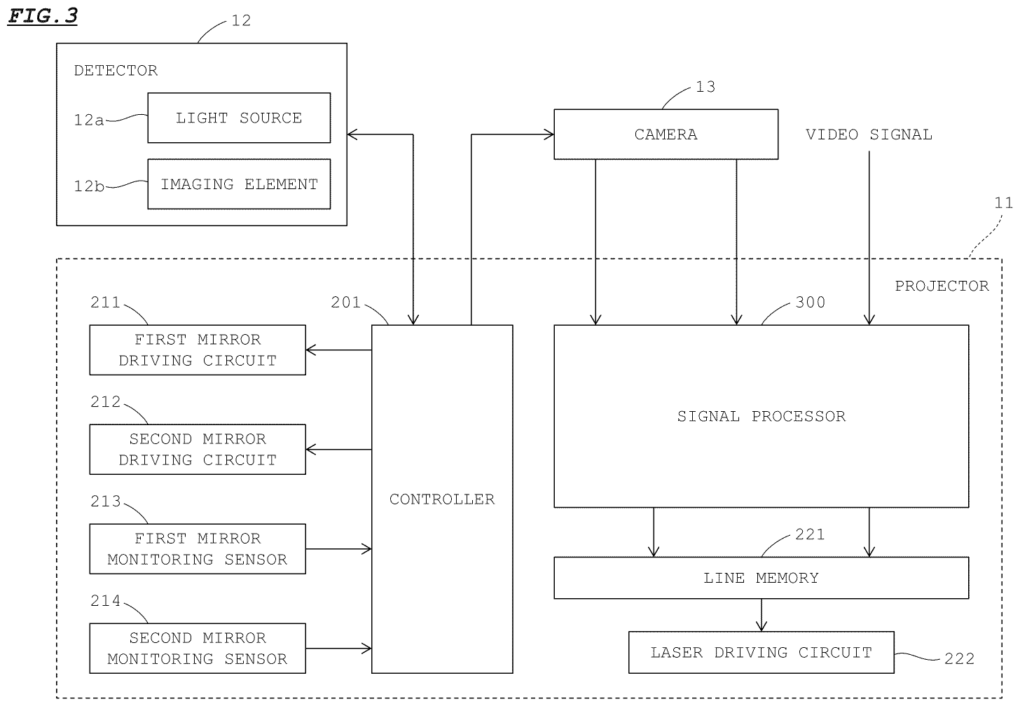

FIG. 3 is a block diagram showing configurations of the projector 11 and the detector 12.

The detector 12 includes a light source 12a and an imaging element 12b, and is connected to a controller 201 of the projector 11. The light source 12a is an LED that emits light having an infrared wavelength, for example. The imaging element 12b is a CMOS image sensor or a CCD image sensor, for example. The light source 12a applies light to the eye E of the user in accordance with an instruction from the controller 201. The imaging element 12b captures an image of the eye E of the user in accordance with an instruction from the controller 201, and outputs the captured image to the controller 201.

The camera 13 captures an image over the range of the field of view of the camera 13 in accordance with an instruction from the controller 201, to generate a video signal, and outputs the generated video signal to a signal processor 300 of a corresponding projector 11. In FIG. 1, the camera 13 on the left side outputs the generated video signal to the signal processor 300 of the projector 11 on the left side, and the camera 13 on the right side outputs the generated video signal to the signal processor 300 of the projector 11 on the right side. Each camera 13 in Embodiment 1 outputs a first captured video signal for high resolution and a second captured video signal for low resolution as described later.

The projector 11 includes the controller 201, a first mirror driving circuit 211, a second mirror driving circuit 212, a first mirror monitoring sensor 213, a second mirror monitoring sensor 214, the signal processor 300, a line memory 221, and a laser driving circuit 222.

The controller 201 includes an arithmetic processing unit such as a CPU and an FPGA, and a memory. Based on the captured image from the detector 12, the controller 201 detects the line of sight of the user by the dark pupil method, the bright pupil method, the corneal reflex method, or the like, for example. Based on the detected line of sight of the user, the controller 201 acquires the viewpoint position in the frame image 20 formed on the retina of the user. In addition, the controller 201 controls the signal processor 300 so as to process video signals from the camera 13 and an external device.

The first mirror driving circuit 211 drives the first mirror 141 of the first scanner 140 in accordance with a driving signal from the controller 201. The second mirror driving circuit 212 drives the second mirror 161 of the second scanner 160 in accordance with a driving signal from the controller 201.

The first mirror monitoring sensor 213 is installed in the first mirror 141, and outputs a detection signal according to rotation of the first mirror 141, to the controller 201. The second mirror monitoring sensor 214 is installed in the second mirror 161, and outputs a detection signal according to rotation of the second mirror 161, to the controller 201. Based on the detection signals from the first mirror monitoring sensor 213 and the second mirror monitoring sensor 214, the controller 201 outputs driving signals to the first mirror driving circuit 211 and the second mirror driving circuit 212 such that the first mirror 141 and the second mirror 161 rotate in desired drive waveforms.

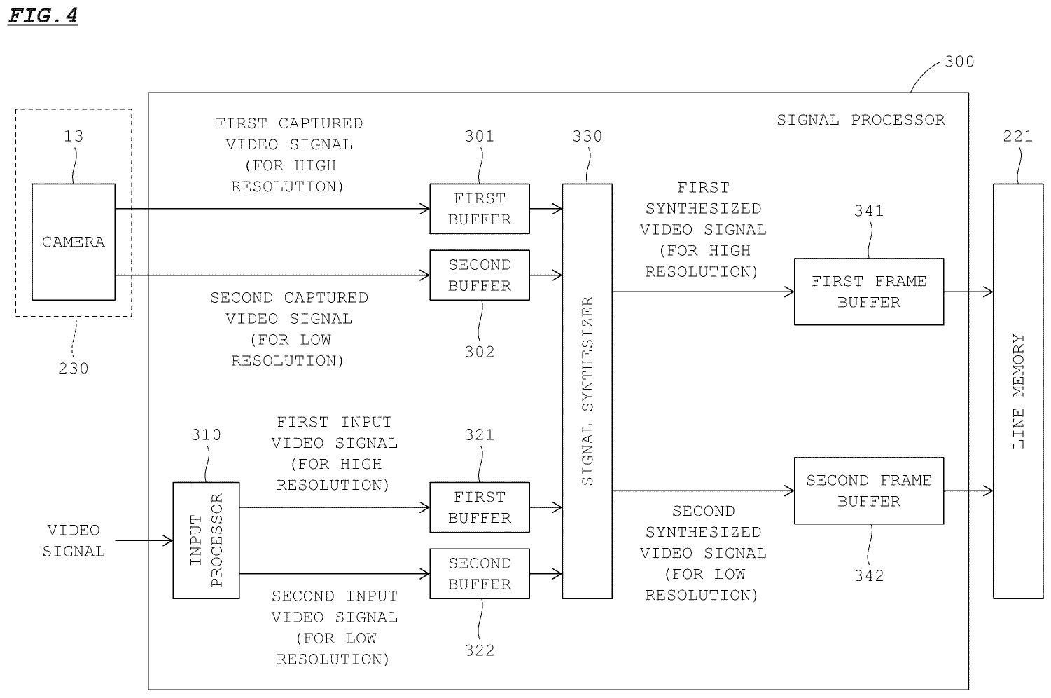

The signal processor 300 processes the video signal from each of the camera 13 and the external device, to generate a video signal for one line. The configuration of the signal processor 300 will be described later with reference to FIG. 4.

The line memory 221 outputs, to the laser driving circuit 222, the video signal for one line outputted from the signal processor 300. The laser driving circuit 222 drives each of the light sources 101, 102, 103 so as to emit light modulated by the video signal for one line outputted from the line memory 221.

FIG. 4 is a block diagram showing a configuration of the signal processor 300.

The signal processor 300 includes a first buffer 301, a second buffer 302, an input processor 310, a first buffer 321, a second buffer 322, a signal synthesizer 330, a first frame buffer 341, and a second frame buffer 342.

In Embodiment 1, an imaging processor 230 is implemented by the camera 13. The camera 13 captures an image over the range of the field of view to generate the first captured video signal for high resolution and the second captured video signal for low resolution. The first buffer 301 is a memory that temporarily stores the first captured video signal outputted from the camera 13 (imaging processor 230). The second buffer 302 is a memory that temporarily stores the second captured video signal outputted from the camera 13 (imaging processor 230).

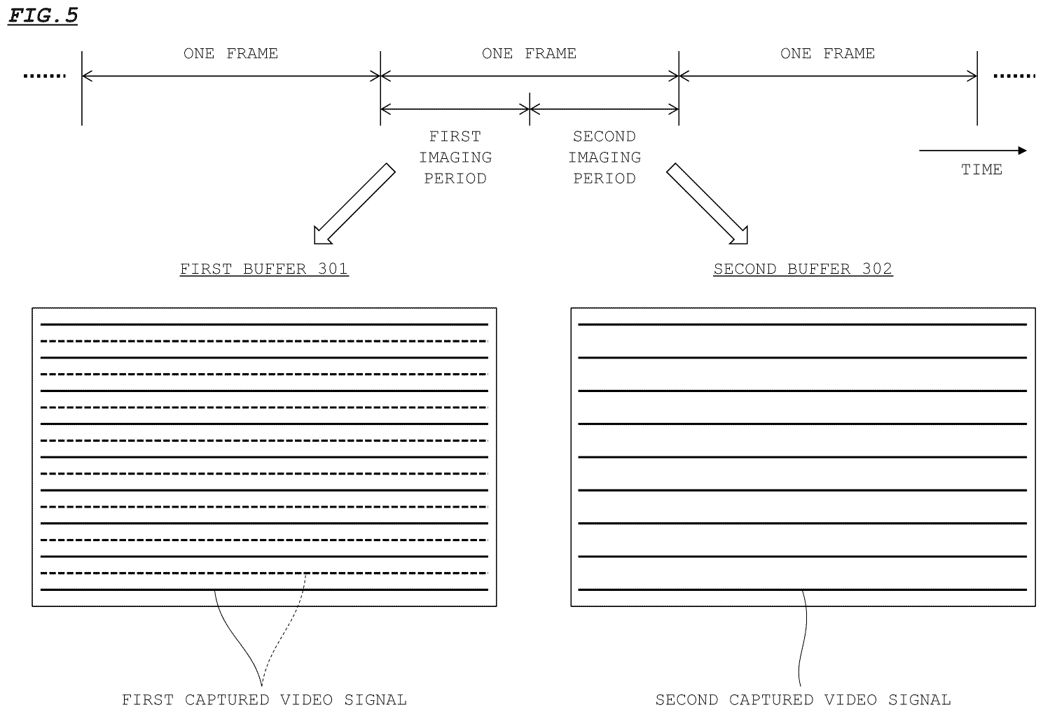

FIG. 5 schematically shows the first and second captured video signals acquired by the camera 13.

The camera 13 generates the first captured video signal in a first imaging period set in one frame, and generates the second captured video signal in a second imaging period different from the first imaging period in one frame. For example, the first imaging period is a first half period in one frame, and the second imaging period is a second half period in one frame. The length of the first imaging period and the length of the second imaging period are the same.

In the first imaging period, the camera 13 drives all light receivers in the camera 13 to generate the first captured video signal for high resolution. On the other hand, in the second imaging period, the camera 13 drives light receivers in every other row out of light receivers, in respective rows, horizontally arranged in the camera 13, to generate the second captured video signal for low resolution.

In FIG. 5, the video signals for respective lines to be stored in the first buffer 301 and the second buffer 302 are indicated by solid lines and broken lines. Out of the first captured video signal to be stored in the first buffer 301, the first captured video signal at each odd-numbered position from the top is indicated by a solid line, and the first captured video signal at each even-numbered position from the top is indicated by a broken line. For convenience, the first captured video signal for 17 lines is shown in the first buffer 301 in FIG. 5. However, the actual number of lines is much larger than this. As for the second captured video signal to be stored in the second buffer 302, the second captured video signal in a state where the lines indicated by the broken lines in the first buffer 301 are omitted is indicated by solid lines.

In the example in FIG. 5, the second captured video signal in the second buffer 302 is a signal in a state where a line of the first captured video signal in the first buffer 301 has been thinned-out every other row, through drive of light receivers in the camera 13. However, the manner of thinning-out the lines is not limited thereto, and for example, the second captured video signal in the second buffer 302 may be a signal in a state where a line of the first captured video signals in the first buffer 301 is thinned-out every three or more rows.

With reference back to FIG. 4, the video signal from the external device is a video signal regarding CG (Computer Graphics), for example. This video signal has a resolution similar to that of the first captured video signal outputted from the camera 13. The input processor 310 performs a thinning process on the video signal inputted from the external device. The first buffer 321 is a memory that temporarily stores the video signal inputted from the external device, i.e., a first input video signal on which the thinning process has not been performed by the input processor 310. The second buffer 322 is a memory that temporarily stores a second input video signal on which the thinning process has been performed by the input processor 310.

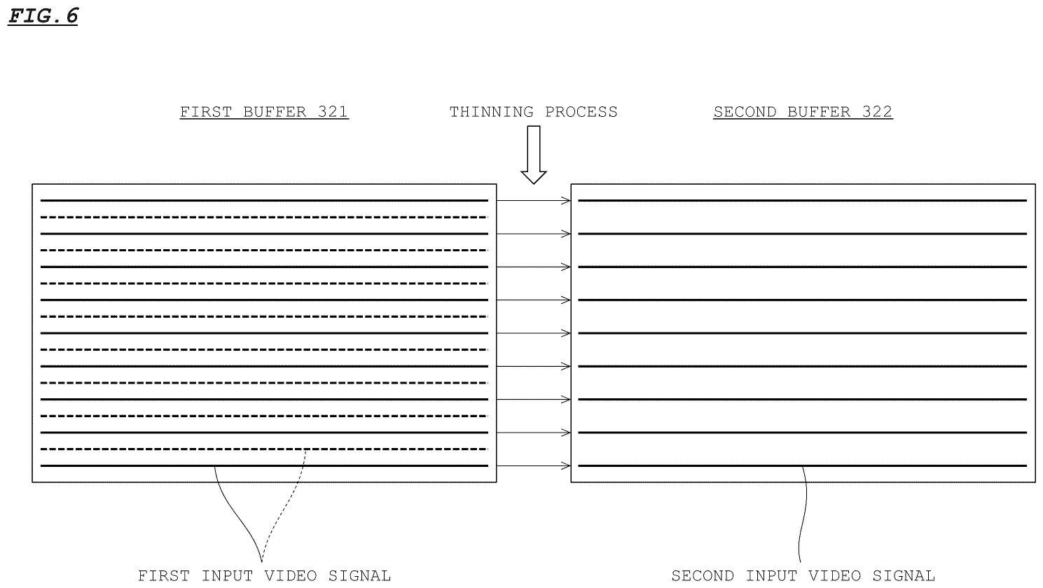

FIG. 6 is a schematic diagram for describing the thinning process performed by the input processor 310.

The input processor 310 generates the first input video signal and the second input video signal having different resolutions from each other, from the video signal inputted from the external device.

In FIG. 6, video signals for respective lines to be stored in the first buffer 321 and the second buffer 322 are indicated by solid lines and broken lines. Out of the first input video signal to be stored in the first buffer 321, the first input video signal at each odd-numbered position from the top is indicated by a solid line, and the first input video signal at each even-numbered position from the top is indicated by a broken line. For convenience, the first input video signal for 17 lines is shown in the first buffer 321 in FIG. 6. However, the actual number of lines is much larger than this. The second input video signal to be stored in the second buffer 322 is a signal obtained by thinning-out the lines indicated by the broken lines in the first buffer 321.

In the example in FIG. 6, the second input video signal in the second buffer 322 is a signal obtained by thinning-out a line of the first input video signal in the first buffer 321, every other row. However, the manner of thinning-out the lines is not limited thereto, and for example, the second input video signal may be a signal obtained by thinning-out one row of the first input video signal in the first buffer 321, every three or more rows. The second input video signal may be generated by mixing lines of the first input video signal adjacent to each other to be stored in the first buffer 321. In the mixing process, for example, adjacent two lines are replaced by one line calculated as the average value of the signals in these two lines.

With reference back to FIG. 4, the signal synthesizer 330 synthesizes the first captured video signal for high resolution stored in the first buffer 301 and the first input video signal for high resolution stored in the first buffer 321, to generate a first synthesized video signal for high resolution for one frame. In addition, the signal synthesizer 330 synthesizes the second captured video signal for low resolution stored in the second buffer 302 and the second input video signal for low resolution stored in the second buffer 322, to generate a second synthesized video signal for low resolution for one frame.

The first frame buffer 341 stores the first synthesized video signal for high resolution for one frame generated by the signal synthesizer 330. The second frame buffer 342 stores the second synthesized video signal for low resolution for one frame generated by the signal synthesizer 330.

The first frame buffer 341 sequentially outputs, to the line memory 221, the first synthesized video signal for one line out of the stored first synthesized video signal for one frame, in accordance with a control signal from the controller 201 (see FIG. 3). The second frame buffer 342 sequentially outputs, to the line memory 221, the second synthesized video signal for one line out of the stored second synthesized video signal for one frame, in accordance with a control signal from the controller 201. To the line memory 221, either one of the first synthesized video signal for one line from the first frame buffer 341 and the second synthesized video signal for one line from the second frame buffer 342 is inputted.

Next, a generation method for the frame image 20 according to a comparative example and a generation method for the frame image 20 according to Embodiment 1 will be described in order.

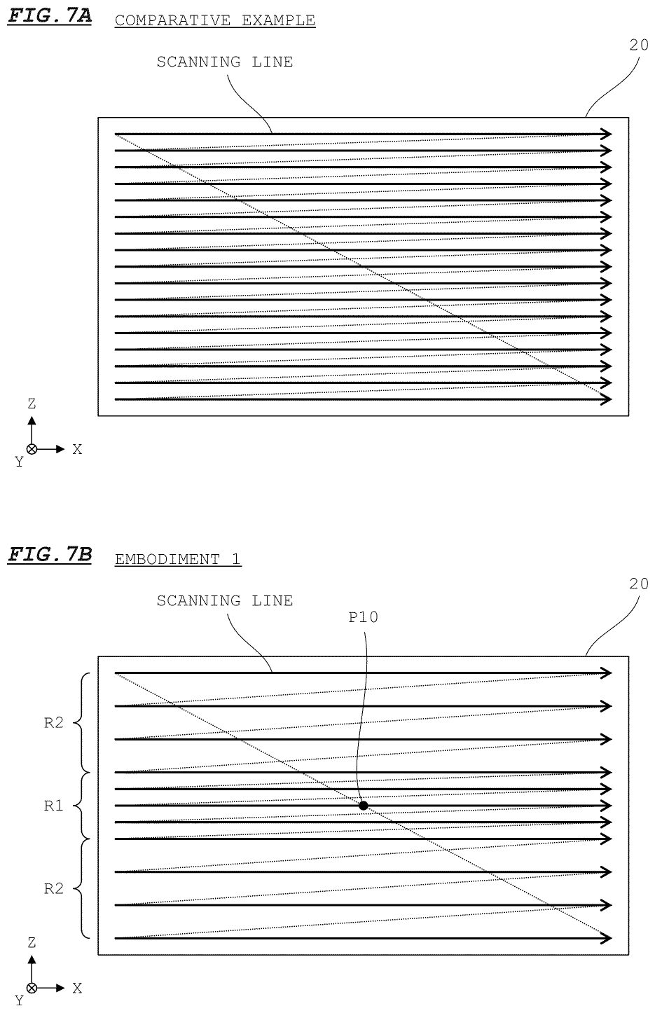

FIG. 7A schematically shows generation of the frame image 20 according to the comparative example.

Scanning with light is performed by the first scanner 140 along the scanning line in the X-axis direction, and the scanning line is changed in the Z-axis direction by the second scanner 160, whereby the frame image 20 is generated on the retina of the eye E of the user. When the scanning line is changed, as indicated by the dotted lines in FIG. 7A, the scanning position is moved by the first scanner 140 and the second scanner 160 in a state where the light sources 101, 102, 103 are turned off. In changing the scanning line, except for the scanning line in the lowermost row, when scanning at the scanning line in each row has ended, the scanning position is moved to the head of the scanning line in the next row. When the scanning at the scanning line in the lowermost row has ended, the scanning position is moved to the head of the scanning line in the uppermost row. In the comparative example, the frame image 20 is generated based on the video signal for high resolution only.

Meanwhile, when the entirety of the frame image 20 has a high resolution as shown in FIG. 7A, the eyes of the user easily become tired. Therefore, in Embodiment 1, as shown in FIG. 7B, in the region outside a predetermined range including the viewpoint position P10 of the user, the resolution (the number of scanning lines) of the frame image 20 is set to be low. Accordingly, the eyes of the user are less likely to become tired.

When the resolution (the number of scanning lines) is to be changed in the frame image 20, it is necessary to perform scanning using a video signal according to the changed resolution (the number of scanning lines) each time. However, since the viewpoint position P10 of the user can dynamically change, if a video signal having each resolution (the number of scanning lines) is to be generated each time in accordance with change in the viewpoint position P10, the video signal cannot be generated in time, and delay in display may occur. When such delay in display occurs, the frame image 20 is distorted, which may result in discomfort for the user.

Therefore, in Embodiment 1, as described above, the (high resolution) first synthesized video signal having a large number of scanning lines is stored in advance in the first frame buffer 341, and the (low resolution) second synthesized video signal having a small number of scanning lines is stored in advance in the second frame buffer 342. Then, in accordance with the viewpoint position P10, the controller 201 switches between the first synthesized video signal from the first frame buffer 341 and the second synthesized video signal from the second frame buffer 342, to generate the frame image 20. Accordingly, the above-described delay in display can be suppressed, and image generation that follows the viewpoint position P10 of the user can be realized.

FIG. 7B schematically shows generation of the frame image 20 according to Embodiment 1.

In Embodiment 1, the controller 201 detects the line of sight of the user, based on the captured image acquired by the detector 12, and acquires the viewpoint position P10 on the frame image 20, based on the detected line of sight. The controller 201 controls the light sources 101, 102, 103, the first scanner 140, and the second scanner 160 such that, to a first image region R1 having a predetermined number of scanning lines including the viewpoint position P10 on the frame image 20, the first synthesized video signal having a high resolution from the first frame buffer 341 is applied, whereby an image is generated. The controller 201 controls the light sources 101, 102, 103, the first scanner 140, and the second scanner 160 such that, to a second image region R2 other than the first image region R1 of the frame image 20, the second synthesized video signal having a low resolution from the second frame buffer 342 is applied, whereby an image is generated.

In FIG. 7B, for convenience, about five scanning lines are shown in the first image region R1, and about eight scanning lines in total are shown in the second image region R2. However, the actual number of scanning lines is much larger than this.

The number of scanning lines included in the first image region R1 may be changed as appropriate. In FIG. 7B, the first image region R1 has ranges corresponding to the same number of scanning lines above and below with respect to the viewpoint position P10. However, the number of scanning lines corresponding to the upper-side range and the number of scanning lines corresponding to the lower-side range may be different from each other.

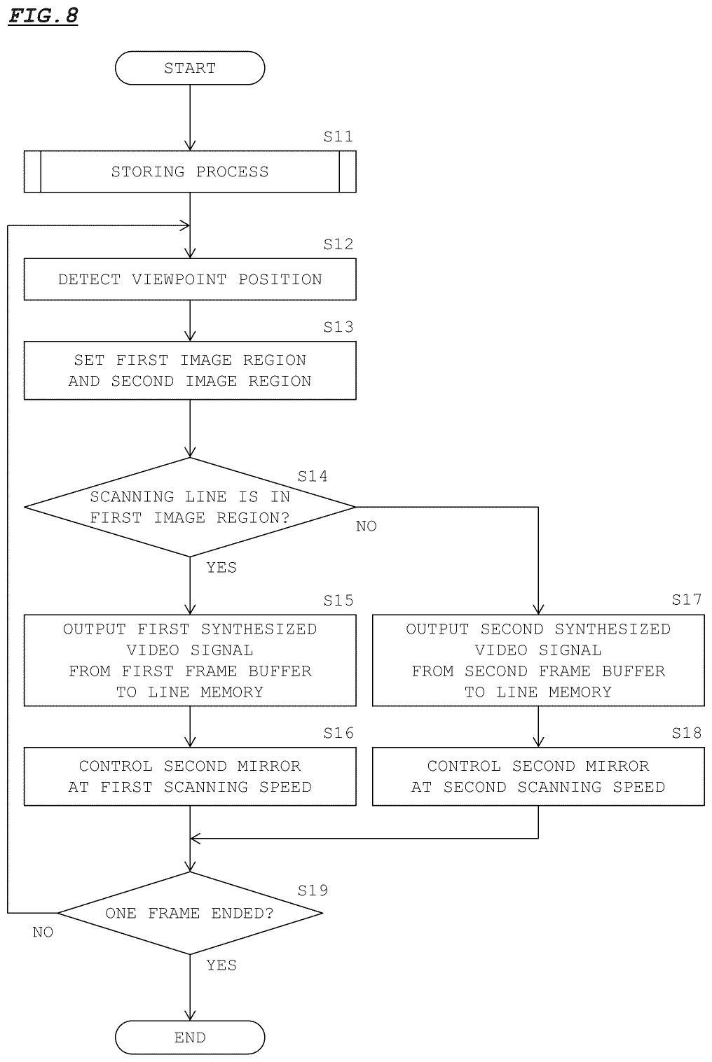

FIG. 8 is a flowchart showing a generation process for the frame image 20 performed by the image generation device 3.

The processes in steps S11 to S19 are processes regarding generation of the frame image 20 corresponding to one frame.

The controller 201 performs a storing process (S11). Accordingly, based on the video signal from the camera 13 and the video signal from the external device, the first synthesized video signal for high resolution for one frame and the second synthesized video signal for low resolution for one frame are stored into the first frame buffer 341 and the second frame buffer 342, respectively.

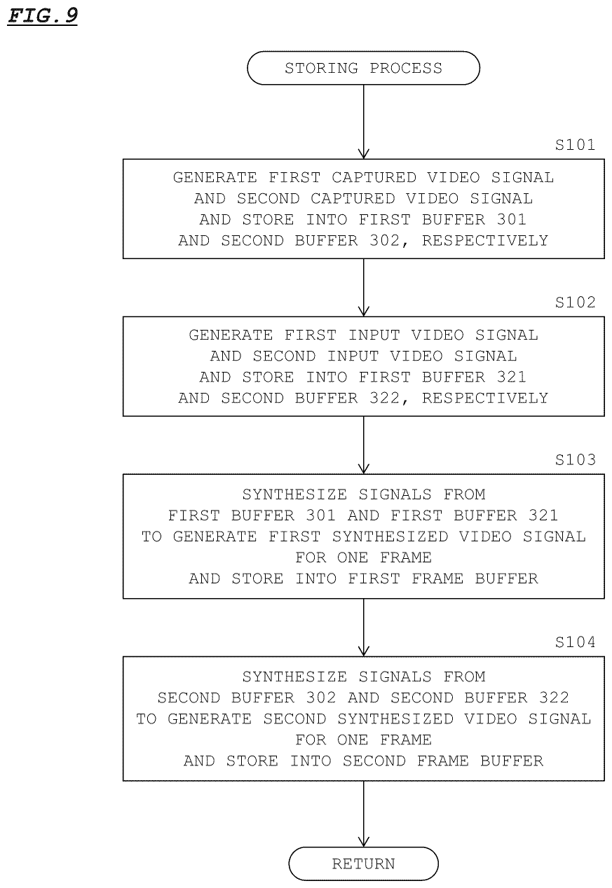

FIG. 9 is a flowchart showing details of the storing process in step S11 in FIG. 8. The process in FIG. 9 is executed by the controller 201 controlling the imaging processor 230 and the signal processor 300.

As shown in FIG. 5, the imaging processor 230 (in Embodiment 1, the camera 13) generates the first captured video signal for high resolution in the first imaging period, and generates the second captured video signal for low resolution in the second imaging period. The imaging processor 230 causes the first buffer 301 and the second buffer 302 to respectively store the generated first captured video signal and second captured video signal (S101).

As shown in FIG. 6, the input processor 310 generates the first input video signal for high resolution and the second input video signal for low resolution, based on the video signal inputted from the external device. Then, the input processor 310 causes the first buffer 321 and the second buffer 322 to respectively store the generated first input video signal and second input video signal (S102). The processes in steps S101, S102 are performed in parallel.

The signal synthesizer 330 synthesizes the first captured video signal stored in the first buffer 301 and the first input video signal of the same lines as those of the first captured video signal out of the first input video signal stored in the first buffer 321, to generate the first synthesized video signal for high resolution for one frame. Then, the signal synthesizer 330 causes the first frame buffer 341 to store the generated first synthesized video signal (S103).

The signal synthesizer 330 synthesizes the second captured video signal stored in the second buffer 302 and the second input video signal of the same lines as those of the second captured video signal out of the second input video signal stored in the second buffer 322, to generate the second synthesized video signal for low resolution for one frame. Then, the signal synthesizer 330 causes the second frame buffer 342 to store the generated second synthesized video signal (S104). The processes in steps S103, S104 are performed in parallel.

With reference back to FIG. 8, the processes in steps S12 to S18 are processes regarding generation of an image for one line.

In parallel with the processes in steps S12 to S18, the controller 201 controls the first mirror driving circuit 211 such that the first mirror 141 repetitively rotates in the same cycle in the process for each line, and drives the laser driving circuit 222, based on the video signal for one line inputted to the line memory 221.

The controller 201 detects the viewpoint position P10 of the user, based on the captured image acquired by the detector 12 (S12). Based on the viewpoint position P10 detected in step S12, the controller 201 sets the first image region R1 and the second image region R2 (S13).

The controller 201 determines whether or not the present scanning line is in the first image region R1 (S14).

When the present scanning line is in the first image region R1 (S14: YES), the controller 201 causes the first synthesized video signal having a high resolution to be outputted from the first frame buffer 341 to the line memory 221 (S15). Accordingly, an image for one line is generated by the first synthesized video signal from the first frame buffer 341. In parallel with this, the controller 201 controls the second mirror driving circuit 212 such that the second mirror 161 rotates at a first scanning speed (S16). As a result, as shown in the first image region R1 in FIG. 7B, the interval between scanning lines adjacent to each other in the up-down direction is narrowed.

On the other hand, when the present scanning line is in the second image region R2 (S14: NO), the controller 201 causes the second synthesized video signal having a low resolution to be outputted from the second frame buffer 342 to the line memory 221 (S17). Accordingly, an image for one line is generated by the second synthesized video signal from the second frame buffer 342. In parallel with this, the controller 201 controls the second mirror driving circuit 212 such that the second mirror 161 rotates at a second scanning speed faster than the first scanning speed (S18). As a result, as shown in the second image region R2 in FIG. 7B, the interval between scanning lines adjacent to each other in the up-down direction is widened.

The controller 201 determines whether or not image generation of one frame has ended (S19). When image generation of one frame has not ended (S19: NO), the process is returned to step S12, and the processes in steps S12 to S18 are performed again. Then, when image generation of one frame has ended (S19: YES), the process in FIG. 8 ends. As a result of the process in FIG. 8 being repeatedly performed, the frame image 20 is continuously generated.

### <Effects of Embodiment 1>

According to Embodiment 1, the following effects are exhibited.

The imaging processor 230 outputs the first captured video signal for forming the frame image 20 having a high resolution (first definition) and the second captured video signal for forming the frame image 20 having a low resolution (second definition). The first frame buffer 341 stores the first synthesized video signal (first captured video signal), and the second frame buffer 342 stores the second synthesized video signal (second captured video signal). The controller 201 controls the light sources 101, 102, 103, the first scanner 140, and the second scanner 160 such that, to the first image region R1, the first synthesized video signal from the first frame buffer 341 is applied, whereby an image is generated. The controller 201 controls the light sources 101, 102, 103, the first scanner 140, and the second scanner 160 such that, to the second image region R2, the second synthesized video signal from the second frame buffer 342 is applied, whereby an image is generated.

According to this configuration, the first captured video signal stored in the first frame buffer 341 and the second captured video signal stored in the second frame buffer 342 are selectively used in accordance with the line of sight of the user, whereby an image for one frame is generated. Therefore, the resolution (definition) of the image can be smoothly switched between the first image region R1 near the line of sight of the user and the other second image region R2.

The frame image 20 in the first image region R1 has a high resolution (first resolution) and the frame image 20 in the second image region R2 has a low resolution (second resolution). The resolutions in this case are defined according to the scanning speed of the second scanner 160.

According to this configuration, in the first image region R1 near the line of sight of the user, the frame image 20 having a high resolution is displayed, and in the second image region R2 in the periphery of the line of sight of the user, the frame image 20 having a low resolution is displayed. Accordingly, the eyes of the user can be made less likely to become tired. In addition, even when the eyesight of the user is poor, the user can clearly grasp the subject or the scenery with reference to the frame image 20 having a high resolution in the first image region R1.

As shown in FIG. 5, the camera 13 outputs the first captured video signal corresponding to a high resolution, in the first imaging period in one frame period, and outputs the second captured video signal corresponding to a low resolution, in the second imaging period different from the first imaging period in one frame period.

According to this configuration, the first captured video signal having a high resolution and the second captured video signal having a low resolution can be smoothly generated.

Based on the video signal from the external device, the input processor 310 outputs the first input video signal for forming the frame image 20 having a high resolution (first definition) and the second input video signal for forming the frame image 20 having a low resolution (second definition). The signal synthesizer 330 causes the first frame buffer 341 to store the first synthesized video signal obtained by synthesizing the first captured video signal and the first input video signal, and causes the second frame buffer 342 to store the second synthesized video signal obtained by synthesizing the second captured video signal and the second input video signal.

According to this configuration, the frame image 20 can be generated by synthesizing the video signal from the imaging processor 230 and the video signal from the external device.

As shown in FIG. 1, the mirror 4 (optical system) guides light with which scanning is performed by the first scanner 140 and the second scanner 160 (scanner), to the eye E of the user wearing the AR glasses 1 (head-mounted display) on his or her head.

According to this configuration, by wearing the AR glasses 1 on the head, the user can grasp the scenery, etc. of which an image has been captured by the camera 13, through the frame image 20 generated by the image generation device 3.

### <Modification 1 of Embodiment 1>

In Embodiment 1, the camera 13 outputs both of the first captured video signal and the second captured video signal. However, not limited thereto, the camera 13 may output one kind of video signal, and a processor placed in a subsequent stage of the camera 13 may generate a video signal having a resolution different therefrom.

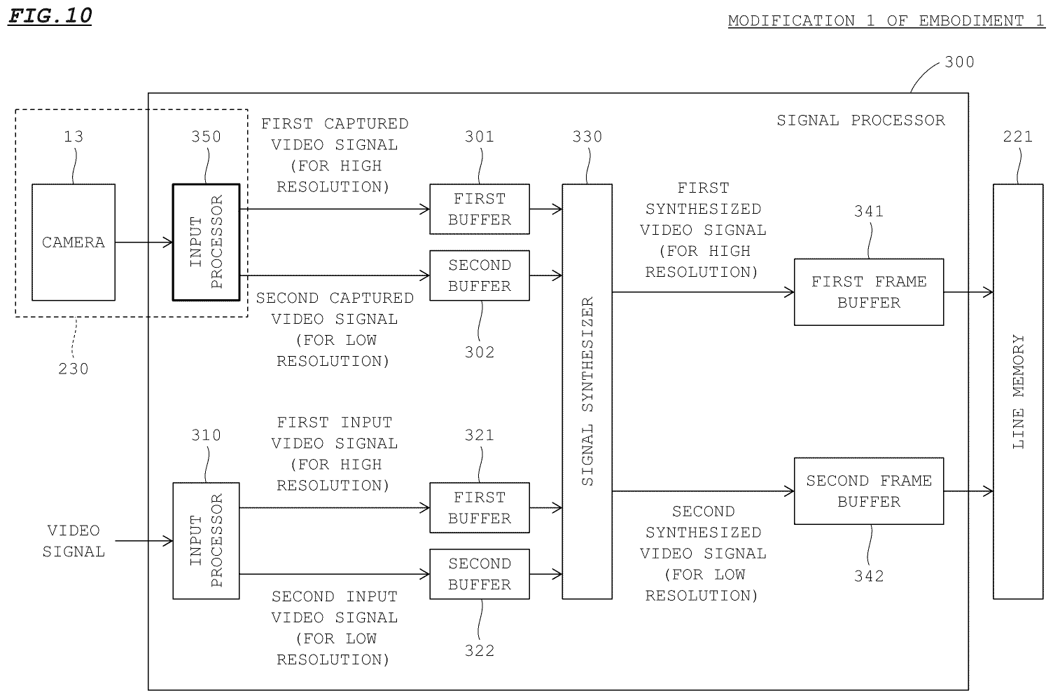

FIG. 10 is a block diagram showing a configuration of the signal processor 300 according to the present modification.

As compared with FIG. 4, the signal processor 300 in FIG. 10 includes an input processor 350 between: the camera 13; and the first buffer 301 and the second buffer 302. The imaging processor 230 in the present modification is composed of the camera 13 and the input processor 350.

The camera 13 in the present modification outputs only a video signal for high resolution similar to the first captured video signal in Embodiment 1. The input processor 350 performs a thinning process similar to the thinning process performed by the input processor 310, on the video signal inputted from the camera 13. The first buffer 301 temporarily stores a first captured video signal which has been outputted from the camera 13 and on which the thinning process has not been performed by the input processor 350. The second buffer 302 temporarily stores a second captured video signal generated as a result of the thinning process being performed by the input processor 350.

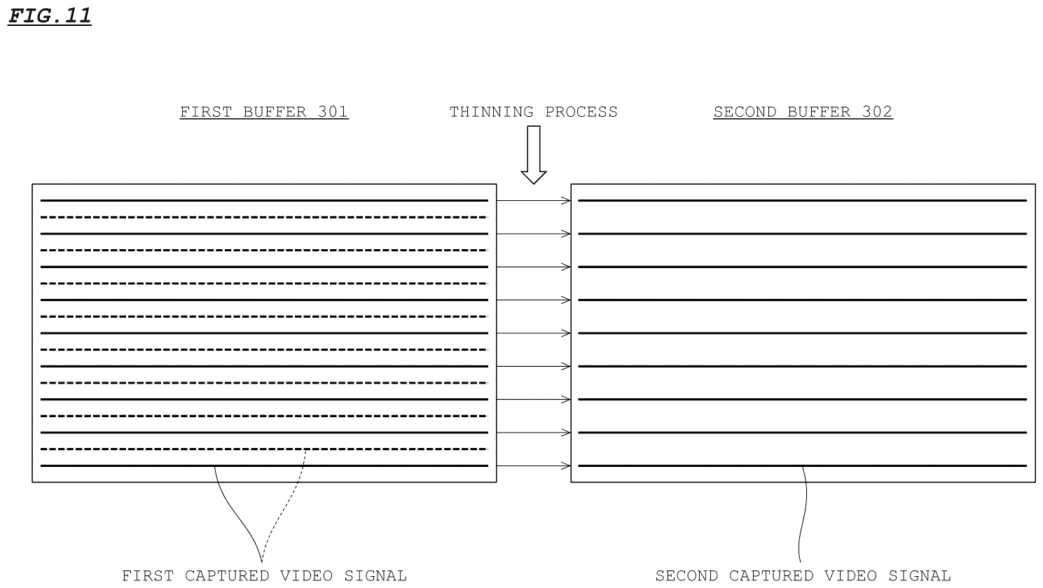

FIG. 11 is a schematic diagram for describing the thinning process performed by the input processor 350.

The input processor 350 generates the first captured video signal and the second captured video signal having different resolutions from each other, from the video signal inputted from the camera 13.

In FIG. 11, video signals for respective lines to be stored in the first buffer 301 and the second buffer 302 are indicated by solid lines and broken lines. Out of the first captured video signal to be stored in the first buffer 301, the first captured video signal at each odd-numbered position from the top is indicated by a solid line, and the first captured video signal at each even-numbered position from the top is indicated by a broken line. For convenience, the first captured video signal for 17 lines are shown in the first buffer 301 in FIG. 11. However, the actual number of lines is much larger than this. The second captured video signal to be stored in the second buffer 302 is a signal obtained by thinning-out the lines indicated by the broken lines in the first buffer 301.

In the example in FIG. 11, the second captured video signal in the second buffer 302 is a signal obtained by thinning-out a line of the first captured video signal in the first buffer 301, every other row. However, the manner of thinning-out the lines is not limited thereto, and for example, the second captured video signal may be a signal obtained by thinning-out one row of the first captured video signal in the first buffer 301, every three or more rows. The second captured video signal may be generated by mixing lines of the first captured video signal adjacent to each other to be stored in the first buffer 301. In the mixing process, for example, adjacent two lines are replaced by one line calculated as the average value of the signals in these two lines.

### <Effects of Modification 1 of Embodiment 1>

The camera 13 outputs the first captured video signal corresponding to a high resolution, and the imaging processor 230 includes the input processor 350 that performs thinning-out or mixing on the first captured video signal having a high resolution to generate the second captured video signal corresponding to a low resolution.

According to this configuration, since it is sufficient that the camera 13 outputs the first captured video signal of one kind only, the configuration of and the process performed by the camera 13 can be simplified. As shown in Embodiment 1, in the configuration in which the first captured video signal and the second captured video signal are obtained in two different imaging periods, if the subject moves at a high speed, the positions of the subject become different from each other in the two kinds of video signals. However, according to the present modification, since the camera 13 outputs the first captured video signal of one kind only, even if the subject has moved at a high speed, the positions of the subject are the same with each other in the first captured video signal and the second captured video signal generated by the input processor 350. Therefore, discomfort for the user based on the first captured video signal and the second captured video signal can be avoided.

### <Modification 2 of Embodiment 1>

In Embodiment 1, both of the video signal from the camera 13 and the video signal from the external device are inputted to the signal processor 300. However, as shown below, only the video signal from the camera 13 may be inputted to the signal processor 300.

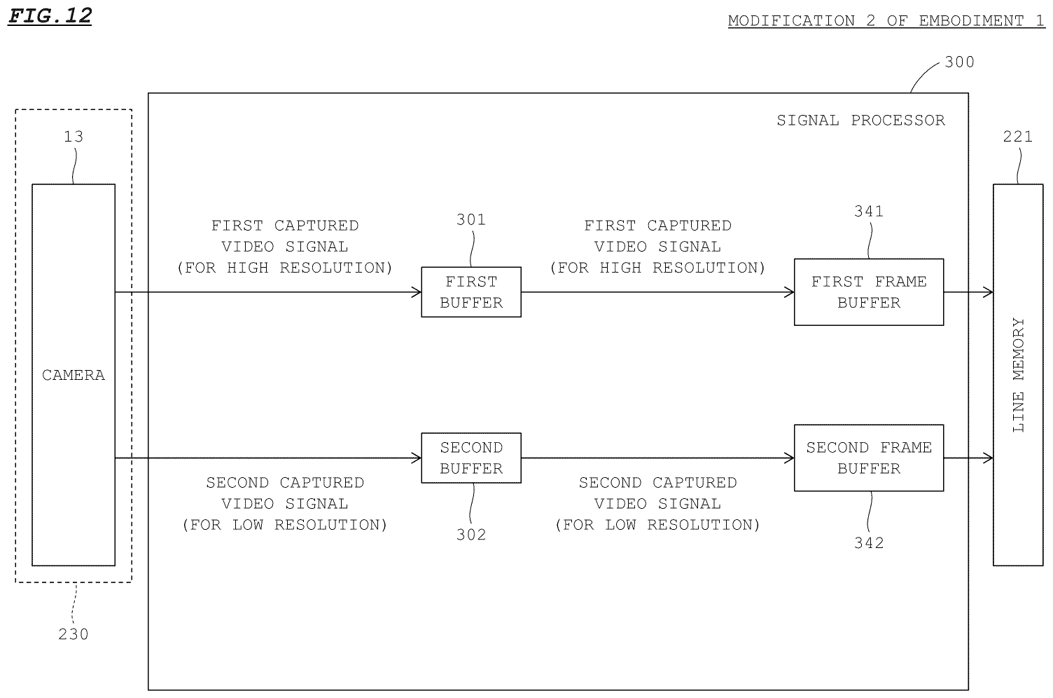

FIG. 12 is a block diagram showing a configuration of the signal processor 300 according to the present modification.

As compared with FIG. 4, the input processor 310, the first buffer 321, the second buffer 322, and the signal synthesizer 330 are omitted in the signal processor 300 in FIG. 12. The first captured video signal from the camera 13 is temporarily stored in the first buffer 301, and then, the first captured video signal for one frame is outputted to the first frame buffer 341. The second captured video signal from the camera 13 is temporarily stored in the second buffer 302, and then, the second captured video signal for one frame is outputted to the second frame buffer 342.

### <Effects of Modification 2 of Embodiment 1>

The first frame buffer 341 stores the first captured video signal from the first buffer 301, and the second frame buffer 342 stores the second captured video signal from the second buffer 302. To the first image region R1, the first captured video signal from the first frame buffer 341 is applied, whereby an image is generated. To the second image region R2, the second captured video signal from the second frame buffer 342 is applied, whereby an image is generated.

According to this configuration, the first captured video signal stored in the first frame buffer 341 and the second captured video signal stored in the second frame buffer 342 are selectively used in accordance with the line of sight of the user, whereby an image for one frame is generated. Therefore, similar to Embodiment 1, the resolution (definition) of the image can be smoothly switched between the first image region R1 near the line of sight of the user and the other second image region R2.

In the present modification as well, similar to Modification 1 shown in FIG. 10, one kind of video signal may be outputted from the camera 13, and the input processor 350 may be placed between: the camera 13; and the first buffer 301 and the second buffer 302.

### <Modification 3 of Embodiment 1>

In Embodiment 1, the first image region R1 is set to a range corresponding to a predetermined number of scanning lines including the viewpoint position P10 based on the line of sight of the user. However, not limited thereto, the first image region R1 may be set to one of a plurality of regions prepared in advance, based on the viewpoint position P10.

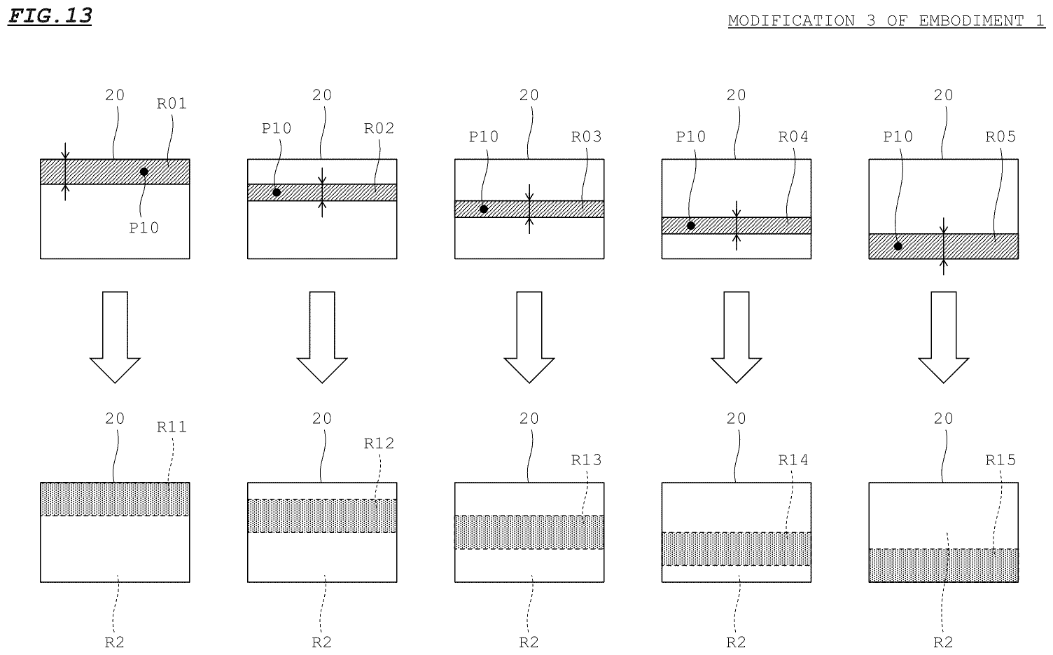

FIG. 13 schematically shows that the first image region R1 is set to one of five regions R11 to R15, based on the viewpoint position P10 according to the present modification.

When the viewpoint position P10 is included in a viewpoint region R01 to R05 in the frame image 20, the controller 201 sets a region R11 to R15 as the first image region, correspondingly. The viewpoint regions R01 to R05 are obtained by dividing the frame image 20 into five in the up-down direction (Z-axis direction). The regions R11 to R15 are regions set so as to correspond to the viewpoint regions R01 to R05, respectively, and each include a predetermined number of scanning lines. When a region R11 to R15 is set as the first image region, the region other than the region R11 to R15 is correspondingly set as the second image region.

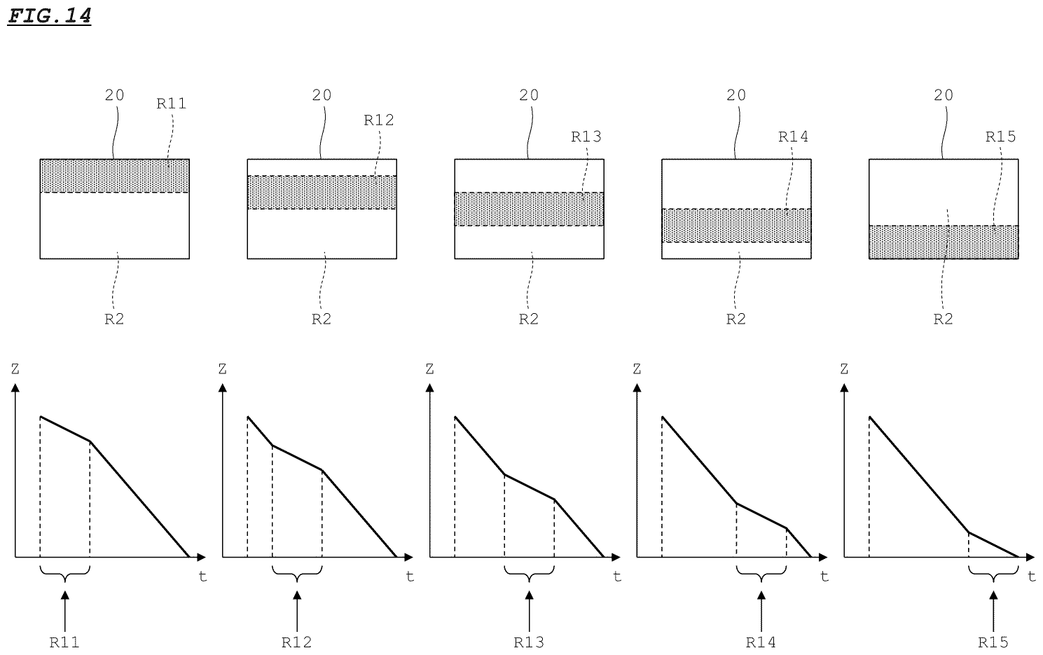

FIG. 14 shows the scanning speed of the second mirror 161 when the five regions R11 to R15 are each set as the first image region according to the present modification.

When the regions R11 to R15 are set as the first image region as shown in the upper part of FIG. 14, the scanning speeds of the second mirror 161 are set as shown in the graphs in the lower part of FIG. 14, respectively. The graphs in the lower part of FIG. 14 each show the scanning speed of the second mirror 161 in scanning for one line. In the five graphs in the lower part, the speeds of the second mirror 161 are reduced in the regions R11 to R15, respectively. Accordingly, when the five regions R11 to R15 are each set as the first image region, the resolution of the image is increased in the range corresponding to each region R11 to R15.

### <Effect of Modification 3 of Embodiment 1>

The controller 201 sets, as the first image region, a region including the viewpoint position P10 out of the plurality of regions R11 to R15 formed by sectioning in advance the frame image 20 in the direction (Z-axis direction) crossing the scanning line.

According to this configuration, since the plurality of regions R11 to R15 are prepared in advance, the first image region including the viewpoint position P10 can be smoothly set.

### Embodiment 2>

The camera 13 in Embodiment 1 outputs two kinds of video signals that are the first captured video signal for high resolution and the second captured video signal for low resolution. In contrast, the camera 13 in Embodiment 2 outputs two kinds of video signals that are a first captured video signal for first luminance and a second captured video signal for second luminance.

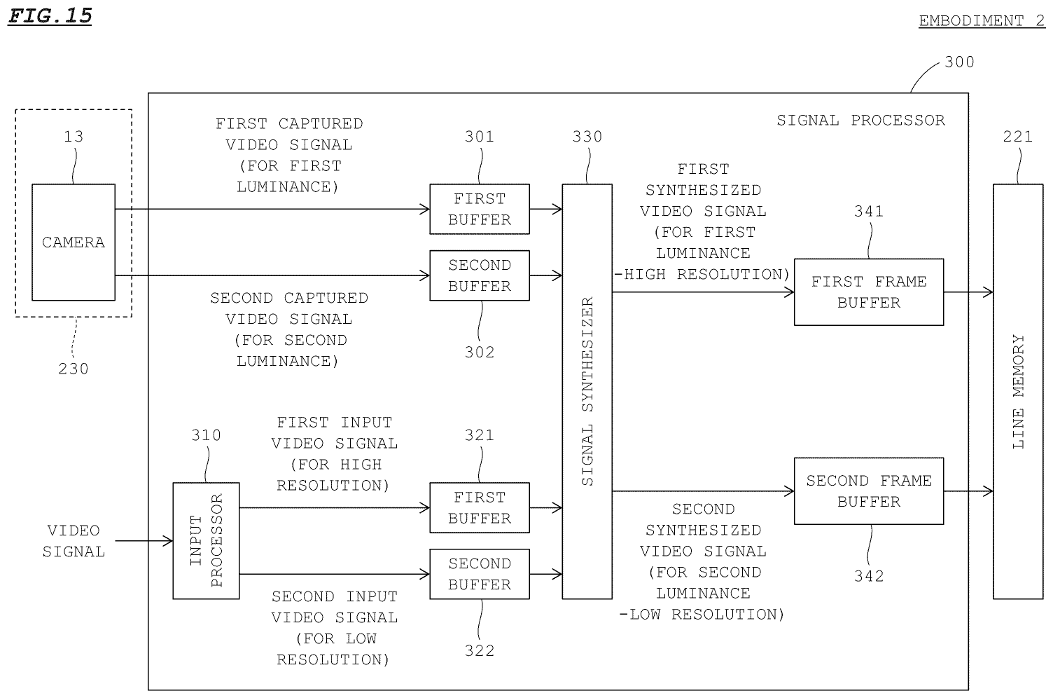

FIG. 15 is a block diagram showing a configuration of the signal processor 300 according to Embodiment 2.

As compared with FIG. 4, in the signal processor 300 in FIG. 15, the two kinds of video signals outputted from the camera 13 are different. That is, the camera 13 outputs the first captured video signal for first luminance and the second captured video signal for second luminance. The signal synthesizer 330 synthesizes the first captured video signal for first luminance stored in the first buffer 301 and the first input video signal for high resolution stored in the first buffer 321, to generate a first synthesized video signal for first luminance and high resolution for one frame. In addition, the signal synthesizer 330 synthesizes the second captured video signal for second luminance stored in the second buffer 302 and the second input video signal for low resolution stored in the second buffer 322, to generate a second synthesized video signal for second luminance and low resolution for one frame.

Here, when acquiring the first captured video signal for first luminance, the camera 13 sets the exposure time of the camera 13 to a first exposure time, and when acquiring the second captured video signal for second luminance, the camera 13 sets the exposure time of the camera 13 to a second exposure time. In the following, a case where the first exposure time is longer than the second exposure time and a case where the first exposure time is shorter than the second exposure time will be described in order.

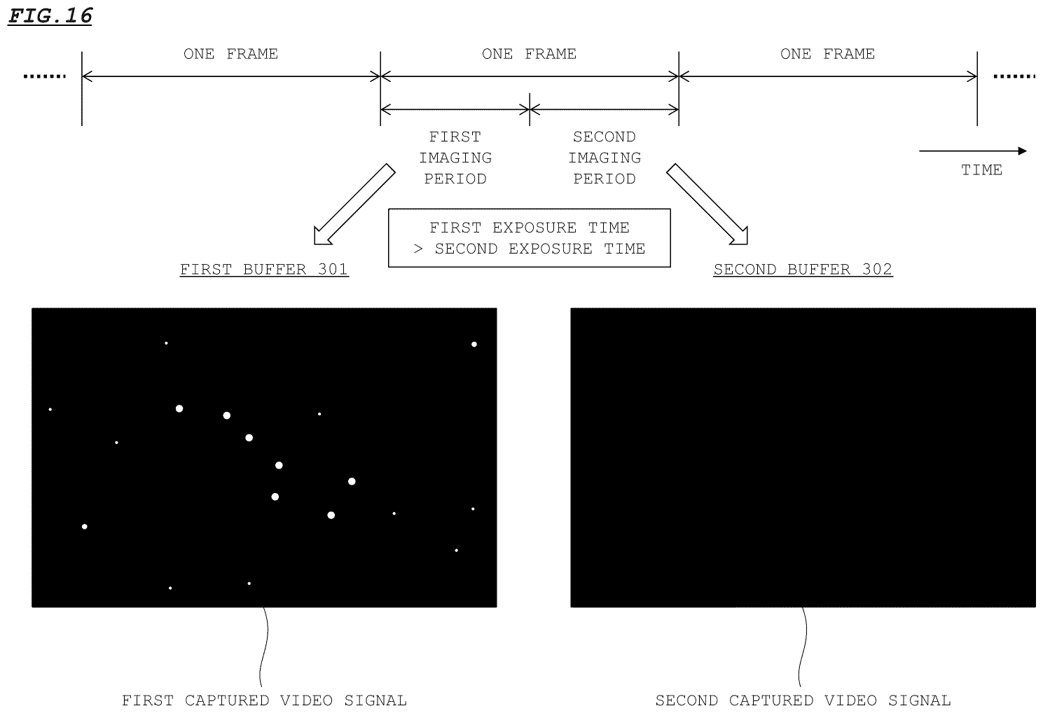

FIG. 16 schematically shows the first captured video signal and the second captured video signal acquired by the camera 13 when the first exposure time is longer than the second exposure time.

In the first imaging period set in one frame, the camera 13 sets the exposure time of the camera 13 to the first exposure time, to generate the first captured video signal. The first captured video signal generated according to the first exposure time is stored into the first buffer 301 as the video signal for first luminance. Meanwhile, in the second imaging period set in one frame, the camera 13 sets the exposure time of the camera 13 to the second exposure time, to generate the second captured video signal. The second captured video signal generated according to the second exposure time is stored into the second buffer 302 as the video signal for second luminance.

For example, when the camera 13 is taking a picture of a night sky, according to the long first exposure time, light in a sufficient amount for taking a picture of stars is incident on the light receivers of the camera 13. Thus, as shown at the lower left of FIG. 16, the first captured video signal will show stars in the night sky. On the other hand, according to the short second exposure time, light in a sufficient amount for taking a picture of stars is not incident on the light receivers of the camera 13. Thus, as shown at the lower right of FIG. 16, the second captured video signal will show only the dark night sky.

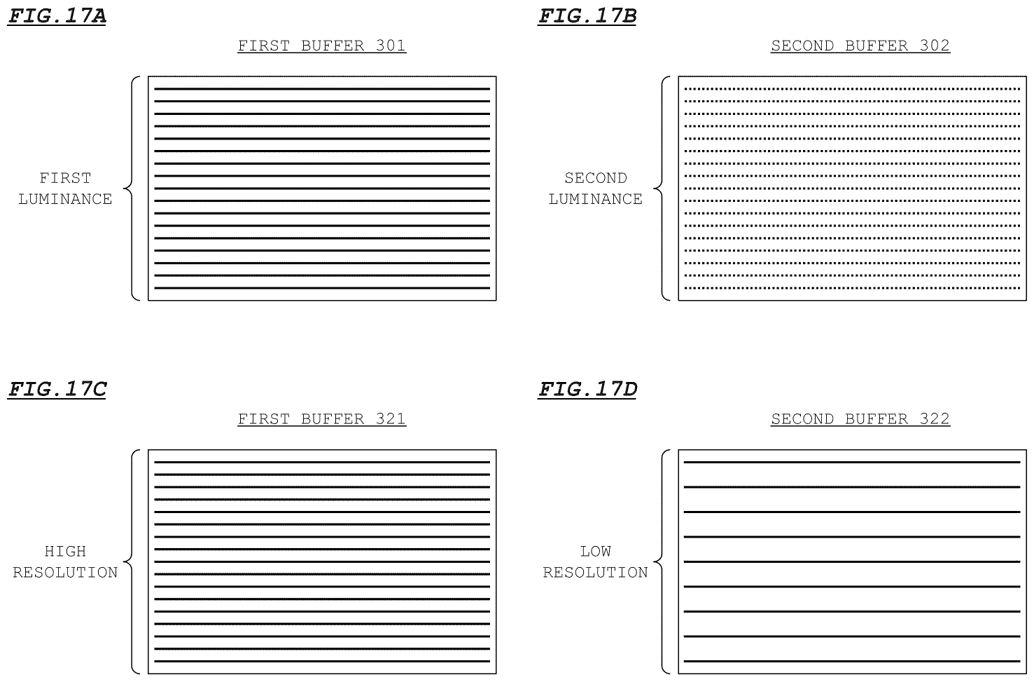

FIGS. 17A to 17D schematically show video signals stored in the first buffer 301, the second buffer 302, the first buffer 321, and the second buffer 322, respectively.

As shown in FIG. 17A, in the first buffer 301, the first captured video signal for first luminance generated by the camera 13, i.e., the bright first captured video signal in the example in FIG. 16, is stored. As shown in FIG. 17B, in the second buffer 302, the second captured video signal for second luminance generated by the camera 13, i.e., the dark second captured video signal in the example in FIG. 16, is stored. For convenience, in FIG. 17B, the video signal having a low luminance is indicated by dotted lines. The first captured video signal and the second captured video signal shown in FIGS. 17A, 17B are each a video signal for high resolution.

As shown in FIG. 17C, in the first buffer 321, the first input video signal for high resolution from the input processor 310 is stored. As shown in FIG. 17D, in the second buffer 322, the second input video signal for low resolution from the input processor 310 is stored.

The signal synthesizer 330 synthesizes the first captured video signal as shown in FIG. 17A and the first input video signal as shown in FIG. 17C, to generate the first synthesized video signal for first luminance and high resolution. The signal synthesizer 330 synthesizes the second captured video signal as shown in FIG. 17B and the second input video signal as shown in FIG. 17D, to generate the second synthesized video signal for second luminance and low resolution.

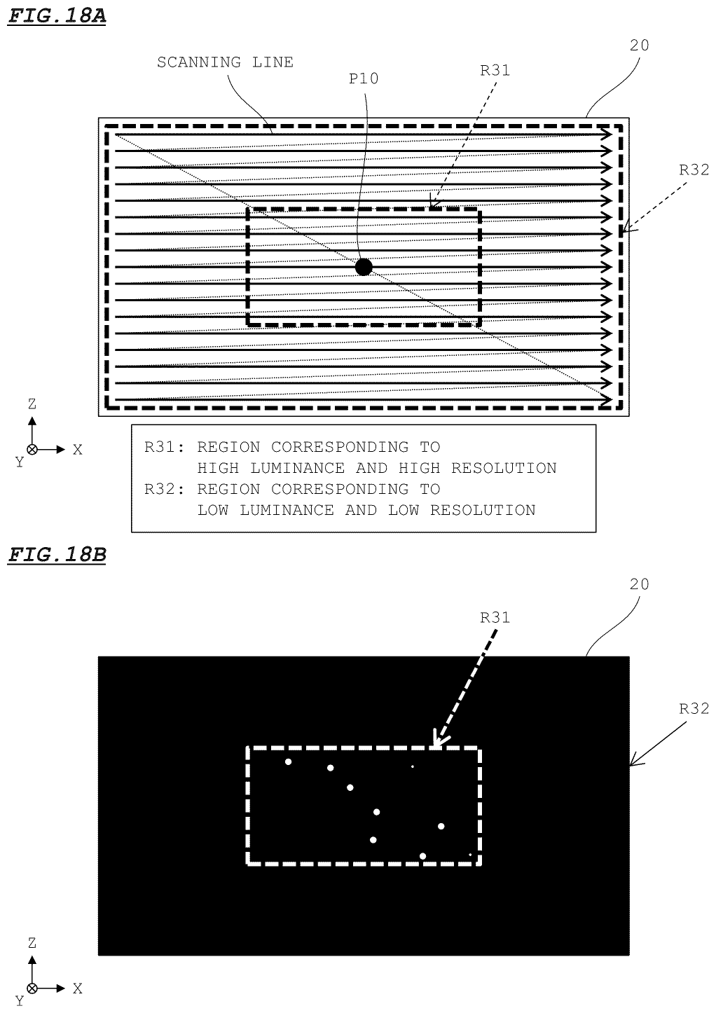

FIG. 18A schematically shows generation of the frame image 20 when the first exposure time is longer than the second exposure time.

The controller 201 sets a first image region R31 having a predetermined size including the viewpoint position P10. The first image region R31 corresponds to the range of the field of view of the user that is +30° in the X-axis direction and +10° in the Z-axis direction with respect to the viewpoint position P10, for example. The controller 201 causes the light sources 101, 102, 103 to emit light, with the first synthesized video signal from the first frame buffer 341 applied to the first image region R31 including the viewpoint position P10. On the other hand, the controller 201 causes the light sources 101, 102, 103 to emit light, with the second synthesized video signal from the second frame buffer 342 applied to a second image region R32 other than the first image region R31.

As shown in FIG. 16, when the first exposure time is longer than the second exposure time, an image having a high luminance and a high resolution is displayed in the first image region R31 near the viewpoint position P10, and an image having a low luminance and a low resolution is displayed in the second image region R32 other than the first image region R31.

Accordingly, as shown in FIG. 18B, stars in the night sky are displayed at a high luminance and a high resolution near the viewpoint position P10, and thus, the user can assuredly view the stars near the viewpoint position P10.

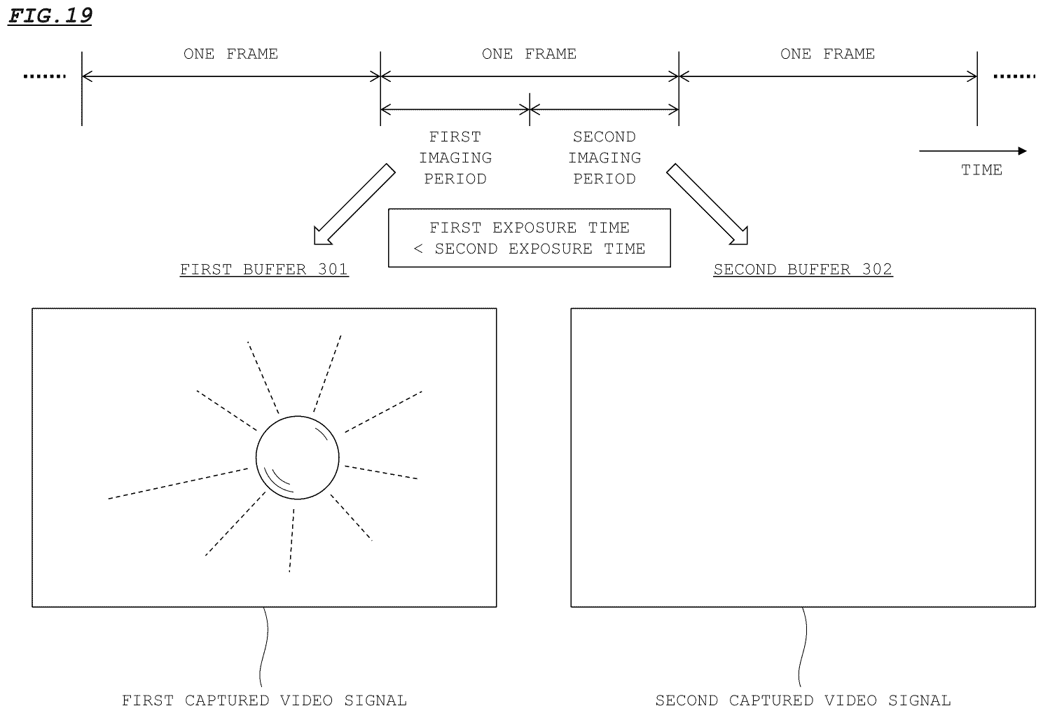

FIG. 19 schematically shows the first captured video signal and the second captured video signal acquired by the camera 13 when the first exposure time is shorter than the second exposure time.

As compared with the example shown in FIG. 16, in the example shown in FIG. 19, the first exposure time is shorter than the second exposure time. Accordingly, the first captured video signal for first luminance generated according to the first exposure time becomes darker than the second captured video signal for second luminance generated according to the second exposure time.

For example, when the camera 13 is taking a picture of the sun, according to the short first exposure time, light in the minimum amount for taking a picture the sun is incident on the light receivers of the camera 13. Thus, as shown at the lower left of FIG. 19, the first captured video signal will show the sun. On the other hand, according to the long second exposure time, the light receivers of the camera 13 become saturated due to the light from the sun. Thus, as shown at the lower right of FIG. 19, the second captured video signal will show a white-out state.

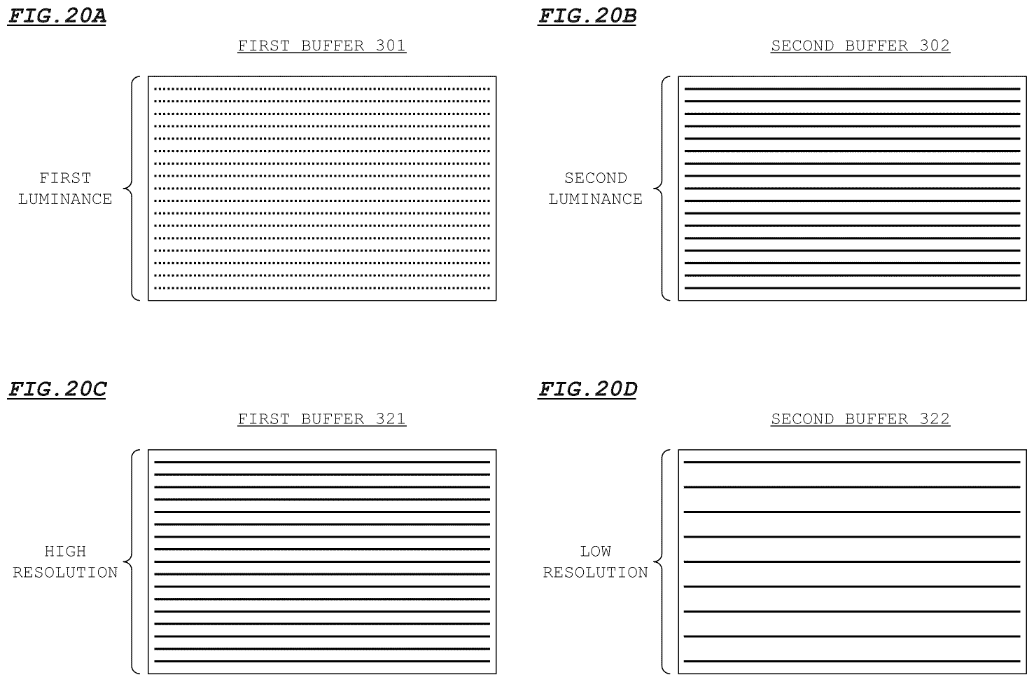

FIGS. 20A to 20D schematically show the video signals stored in the first buffer 301, the second buffer 302, the first buffer 321, and the second buffer 322, respectively.

As shown in FIG. 20A, in the first buffer 301, the first captured video signal for first luminance generated by the camera 13, i.e., the dark first captured video signal in the example in FIG. 19, is stored. As shown in FIG. 20B, in the second buffer 302, the second captured video signal for second luminance generated by the camera 13, i.e., the bright second captured video signal in the example in FIG. 19, is stored. As shown in FIGS. 20C, 20D, in the first buffer 321, the first input video signal for high resolution is stored, and in the second buffer 322, the second input video signal for low resolution is stored.

In this case as well, similar to FIGS. 17A to 17D, the signal synthesizer 330 synthesizes the first captured video signal as shown in FIG. 20A and the first input video signal as shown in FIG. 20C, to generate the first synthesized video signal for first luminance and high resolution. In addition, the signal synthesizer 330 synthesizes the second captured video signal as shown in FIG. 20B and the second input video signal as shown in FIG. 20D, to generate the second synthesized video signal for second luminance and low resolution.

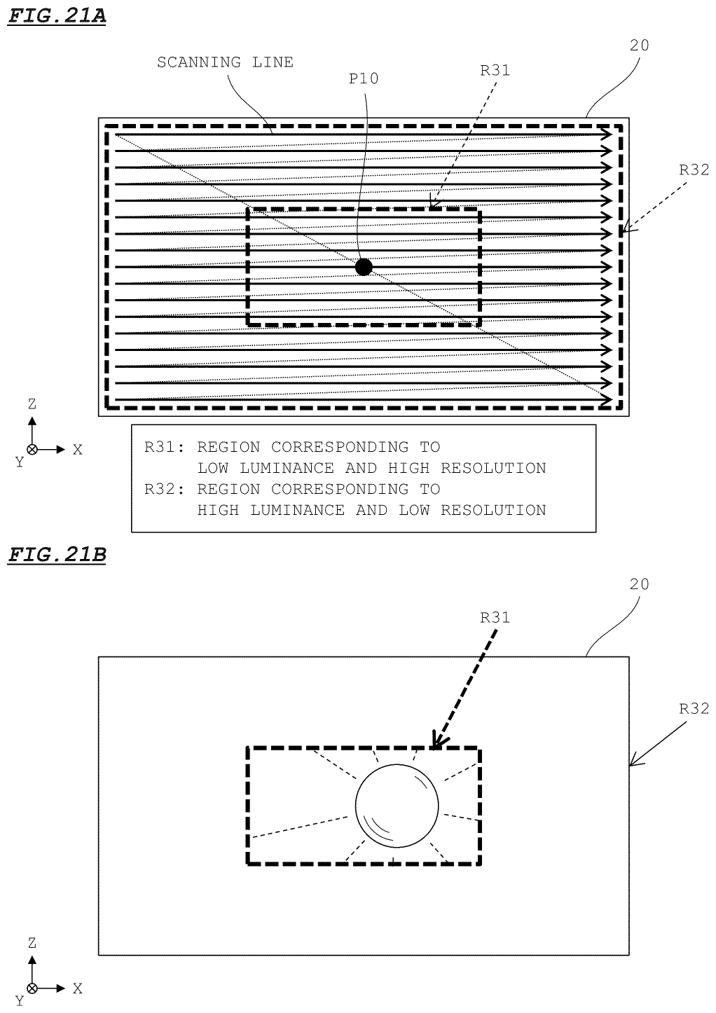

FIG. 21A schematically shows generation of the frame image 20 when the first exposure time is shorter than the second exposure time.

In this case as well, the controller 201 sets the first image region R31 similar to that in FIG. 18A, and applies the first synthesized video signal from the first frame buffer 341 to the first image region R31 including the viewpoint position P10. In addition, the controller 201 applies the second synthesized video signal from the second frame buffer 342 to the second image region R32 other than the first image region R31. As shown in FIG. 19, when the first exposure time is shorter than the second exposure time, an image having a low luminance and a high resolution is displayed in the first image region R31 near the viewpoint position P10, and a high luminance and a low resolution is displayed in the second image region R32 other than the first image region R31. Accordingly, as shown in FIG. 21B, the sun in the sky is displayed at a low luminance near the viewpoint position P10, and thus, the user can assuredly view the sun near the viewpoint position P10.

In FIGS. 18A, 18B and FIGS. 21A, 21B, the first image region R31 is set so as to correspond to the range of the field of view of the user that is +30° in the X-axis direction and +10° in the Z-axis direction with respect to the viewpoint position P10. However, the range of the angle set with respect to the viewpoint position P10 is not limited thereto. The range in the Z-axis direction of the first image region R31 may be a range corresponding to a predetermined number of scanning lines including the viewpoint position P10.

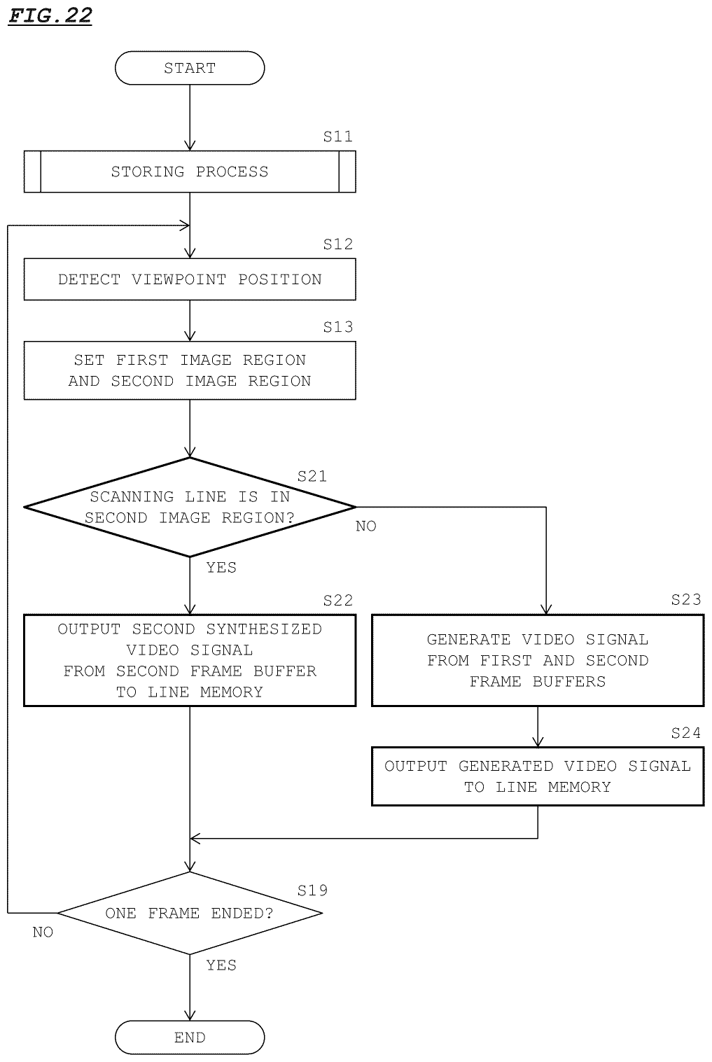

FIG. 22 is a flowchart showing a generation process of the frame image 20 performed by the image generation device 3 according to Embodiment 2.

As compared with the process in Embodiment 1 shown in FIG. 8, in the process in FIG. 22, steps S21 to S24 are added in place of steps S14 to S18. The process in FIG. 22 is similarly executed in both of a case where the first exposure time is longer than the second exposure time, and a case where the first exposure time is shorter than the second exposure time. In the process in FIG. 22, rotation in the Z-axis negative direction of the second mirror 161 is performed at a constant scanning speed. In the following, processes different from those in FIG. 8 will be described.

The controller 201 determines whether or not the present scanning line is included only in the second image region R32 (S21).

When the present scanning line is included only in the second image region R32 (S21: YES), the controller 201 causes the second synthesized video signal to be outputted from the second frame buffer 342 to the line memory 221 (S22). Accordingly, in Embodiment 2, an image for one line is generated according to the second synthesized video signal for second luminance and low resolution.

On the other hand, when the present scanning line is included both in the first image region R31 and the second image region R32 (S21: NO), the controller 201 generates a video signal for one line, from the first synthesized video signal from the first frame buffer 341 and the second synthesized video signal from the second frame buffer 342, in accordance with the position of the first image region R31 (S23). The controller 201 causes the video signal generated in step S23 to be outputted to the line memory 221 (S24). Accordingly, in Embodiment 2, the image for the first image region R31 in the image for one line is generated according to the first synthesized video signal for first luminance and high resolution. The image for the second image region R32 in the image for one line is generated according to the second synthesized video signal for second luminance and low resolution.

### <Effects of Embodiment 2>

The imaging processor 230 outputs the first captured video signal for forming the frame image 20 having the first luminance (first definition) and the second captured video signal for forming the frame image 20 having the second luminance (second definition). The first frame buffer 341 stores the first synthesized video signal (first captured video signal) and the second frame buffer 342 stores the second synthesized video signal (second captured video signal).

According to this configuration, similar to Embodiment 1, the first captured video signal stored in the first frame buffer 341 and the second captured video signal stored in the second frame buffer 342 are selectively used in accordance with the line of sight of the user, whereby an image for one frame is generated. Therefore, the luminance (definition) of the image can be smoothly switched between the first image region R1 near the line of sight of the user and the other second image region R2.

In the case of FIG. 18B, the frame image 20 in the first image region R31 has a high luminance (first definition, first luminance), and the frame image 20 in the second image region R32 has a low luminance (second definition, second luminance). In the case of FIG. 21B, the frame image 20 in the first image region R31 has a low luminance (first definition, first luminance), and the frame image 20 in the second image region R32 has a high luminance (second definition, second luminance). As shown in FIGS. 16, 19, the first definition and the second definition are respectively set according to the first exposure time and the second exposure time that are used when the camera 13 performs capturing of an image.

According to this configuration, when the subject of the camera 13 is dark, if the first exposure time is set to be longer than the second exposure time, the frame image 20 having a high luminance is displayed in the first image region R31 near the line of sight of the user, and the frame image 20 having a low luminance is displayed in the second image region R32 in the periphery of the line of sight of the user, as shown in FIG. 18B. When the subject of the camera 13 is bright, if the first exposure time is set to be shorter than the second exposure time, the frame image 20 having a low luminance is displayed in the first image region R31 near the line of sight of the user, and the frame image 20 having a high luminance is displayed in the second image region R32 in the periphery of the line of sight of the user, as shown in FIG. 21B. Accordingly, the user can view the subject of the camera 13 at an appropriate luminance.

In the present embodiment as well, similar to Modification 1 shown in FIG. 10, one kind of video signal may be outputted from the camera 13, and the input processor 350 may be placed between: the camera 13; and the first buffer 301 and the second buffer 302. In this case, the camera 13 outputs the first captured video signal for first luminance, and the input processor 350 performs a process for causing the first captured video signal to have a low luminance or a high luminance, to generate the second captured video signal for second luminance.

Similar to Modification 2 of Embodiment 1, the configuration for processing the video signal from the external device, i.e., the input processor 310, the first buffer 321, the second buffer 322, and the signal synthesizer 330, may be omitted.

### Embodiment 3

In Modification 1 of Embodiment 1, the input processor 350, 310 each output two kinds of video signals for high resolution and for low resolution. In contrast, in Embodiment 3, the input processors 350, 310 each output video signals for high gradation and for low gradation.

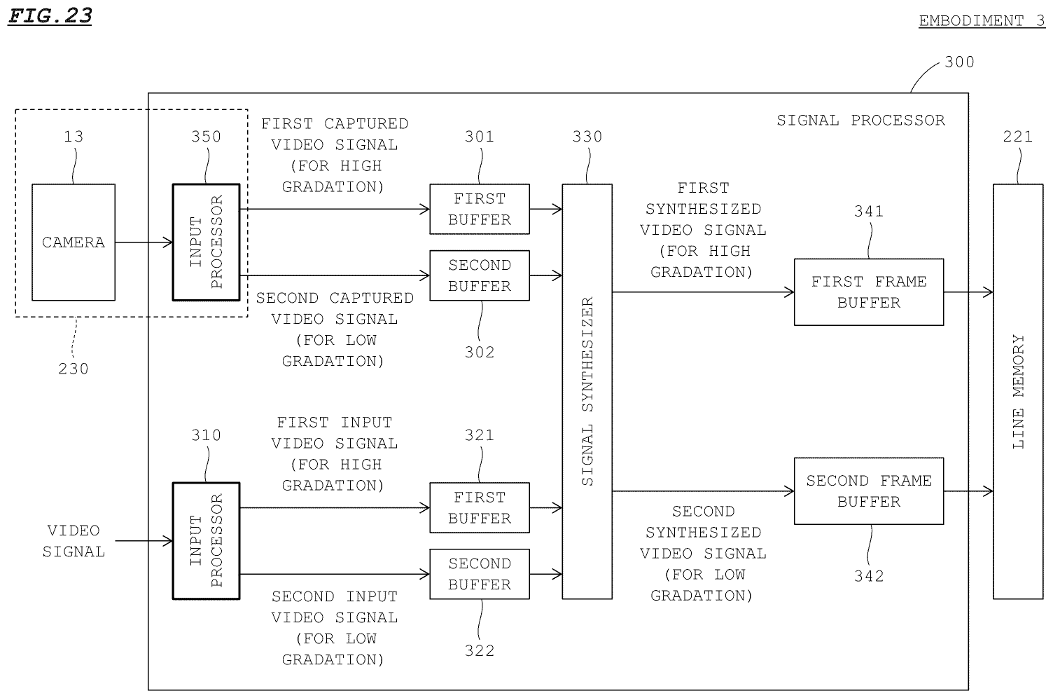

FIG. 23 is a block diagram showing a configuration of the signal processor 300 according to Embodiment 3.

As compared with Modification 1 of Embodiment 1 in FIG. 10, in the signal processor 300 in FIG. 23, the two kinds of video signals outputted from each of the input processors 350, 310 are different.

The input processor 350 outputs, to the first buffer 301, a first captured video signal for high gradation outputted from the camera 13, as is, and outputs, to the second buffer 302, a second captured video signal generated by lowering the gradation of the first captured video signal for high gradation outputted from the camera 13. The first captured video signal outputted from the camera 13 is a video signal in which shade is expressed in 256 gradations, for example, and the second captured video signal generated through the gradation lowering performed by the input processor 350 is a two-gradation video signal, for example. The first captured video signal and the second captured video signal are each a video signal for high resolution.

The input processor 310 outputs, to the first buffer 321, the first input video signal for high gradation outputted from the external device, as is, and outputs, to the second buffer 322, a second input video signal generated by lowering the gradation of the first input video signal for high gradation outputted from the external device. The first input video signal outputted from the external device is a video signal in which shade is expressed in 256 gradations, for example, and the second input video signal generated through the gradation lowering performed by the input processor 310 is a two-gradation video signal, for example. The first input video signal and the second input video signal are each a video signal for high resolution.

The signal synthesizer 330 synthesizes the first captured video signal for high gradation stored in the first buffer 301 and the first input video signal for high gradation stored in the first buffer 321, to generate a first synthesized video signal for high gradation for one frame. In addition, the signal synthesizer 330 synthesizes the second captured video signal for low gradation stored in the second buffer 302 and the second input video signal for low gradation stored in the second buffer 322, to generate a second synthesized video signal for low gradation for one frame.

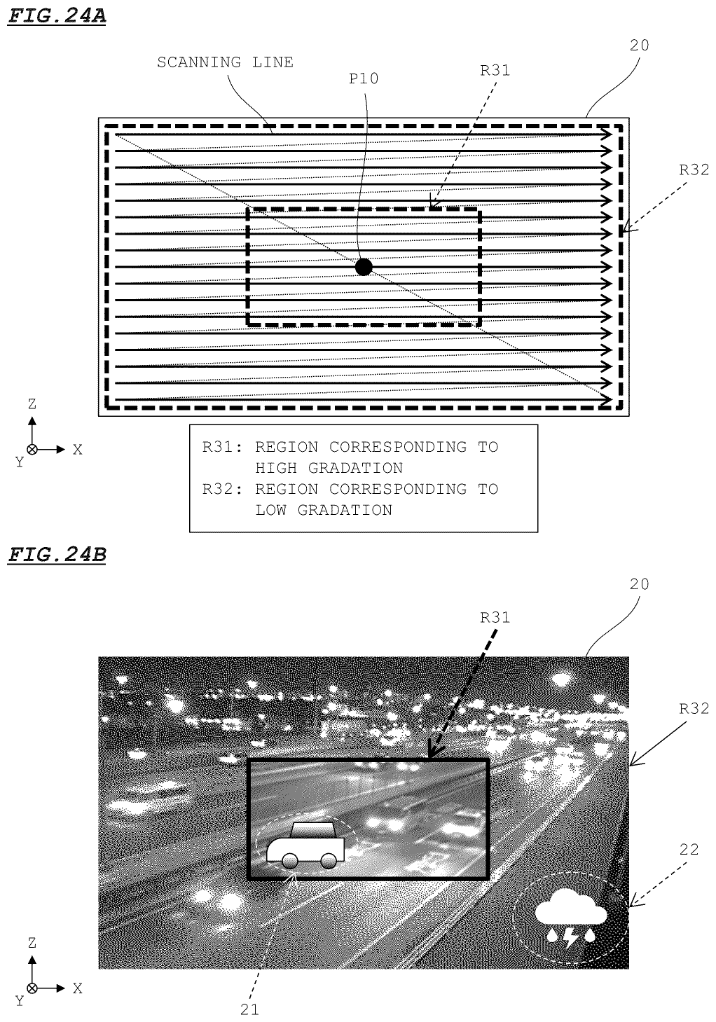

FIG. 24A schematically shows generation of the frame image 20 according to Embodiment 3.

In this case as well, similar to Embodiment 2 shown in FIG. 18A and FIG. 21A, the controller 201 sets the first image region R31 having a predetermined size including the viewpoint position P10. The controller 201 applies the first synthesized video signal from the first frame buffer 341 to the first image region R31 including the viewpoint position P10. In addition, the controller 201 applies the second synthesized video signal from the second frame buffer 342 to the second image region R32 other than the first image region R31.

Accordingly, as shown in FIG. 24B, an image having a high gradation is displayed in the first image region R31 near the viewpoint position P10, and an image having a low gradation is displayed in the second image region R32 other than the first image region R31. Specifically, in the first image region R31, actually travelling cars are displayed according to the first captured video signal having a high gradation, and an illustration of a car in fine gradations is displayed according to the first input video signal having a high gradation. In addition, in the second image region R32, the statuses of cars and roads are displayed according to the second captured video signal having a low gradation, and a weather mark is displayed according to the second input video signal having a low gradation.

In Embodiment 3 as well, similar to Embodiment 2 shown in FIG. 22, a generation process of the frame image 20 is performed.

### <Effects of Embodiment 3>

The imaging processor 230 outputs the first captured video signal for forming the frame image 20 having a high gradation (first definition) and the second captured video signal for forming the frame image 20 having a low gradation (second definition). The first frame buffer 341 stores the first synthesized video signal (first captured video signal), and the second frame buffer 342 stores the second synthesized video signal (second captured video signal).

According to this configuration, similar to Embodiment 1, the first captured video signal stored in the first frame buffer 341 and the second captured video signal stored in the second frame buffer 342 are selectively used in accordance with the line of sight of the user, whereby an image for one frame is generated. Therefore, the gradation (definition) of the image can be smoothly switched between the first image region R31 near the line of sight of the user and the other second image region R32.

The frame image 20 in the first image region R31 has a high gradation (first definition, first gradation), and the frame image 20 in the second image region R32 has a low gradation (second definition, second gradation). The first gradation and the second gradation in this case define the luminance resolution of the first captured video signal and the second captured video signal, respectively.

According to this configuration, the frame image 20 having a high gradation is displayed in the first image region R31 near the line of sight of the user, and the frame image 20 having a low gradation is displayed in the second image region R32 in the periphery of the line of sight of the user. Accordingly, the eyes of the user can be made less likely to become tired. In addition, even when the eyesight of the user is poor, the user can clearly grasp the subject with reference to the frame image 20 having a high gradation in the first image region R31.

The camera 13 outputs the first captured video signal corresponding to a high gradation (first gradation), and the imaging processor 230 includes the input processor 350 that performs a process of gradation lowering on the first captured video signal having a high gradation to generate the second captured video signal corresponding to a low gradation (second gradation).

According to this configuration, video signals having a high gradation and a low gradation can be smoothly generated.

The input processor 350 may be formed integrally with the camera 13. The video signal from the external device may be the first input video signal for high gradation and the second input video signal for low gradation. In this case, the input processor 310 is omitted.

Similar to Modification 2 of Embodiment 1, the configuration for processing the video signal from the external device, i.e., the input processor 310, the first buffer 321, the second buffer 322, and the signal synthesizer 330 may be omitted.

### <Other Modifications>

The configurations of the image generation device 3 and the AR glasses 1 (head-mounted display) can be modified in various ways other than the configurations shown in the embodiments and modifications above.

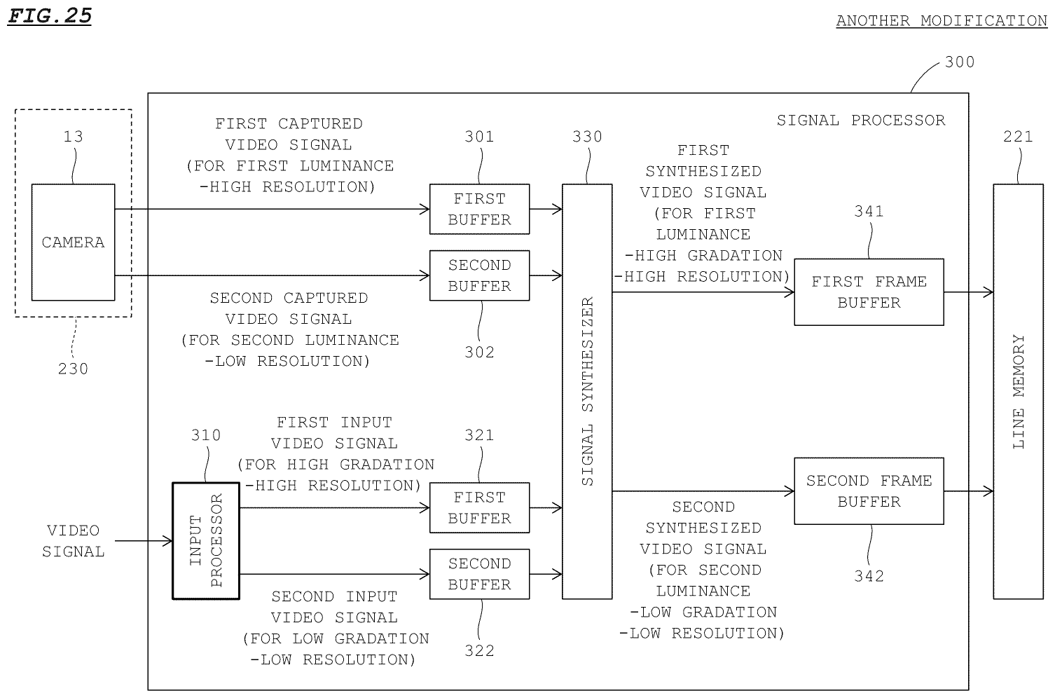

In Embodiments 1 to 3 above, the two kinds of video signals outputted from the imaging processor 230 and the two kinds of video signals outputted from the input processor 310 are not limited to the above. That is, the first captured video signal and the second captured video signal may be video signals different from each other in one kind or more of definitions among a plurality of kinds of definitions (resolution, luminance, gradation, etc.). Similarly, the first input video signal and the second input video signal may be video signals different from each other in one kind or more of definitions. For example, the kind of the video signal that is outputted may be set as shown in FIG. 25.

FIG. 25 is a block diagram showing a configuration of the signal processor 300 according to a modification in this case.

As compared with Embodiment 2 shown in FIG. 15, in the signal processor 300 in FIG. 25, the imaging processor 230 outputs a first captured video signal for first luminance and high resolution and a second captured video signal for second luminance and low resolution. The input processor 310 outputs a first input video signal for high gradation and high resolution and a second input video signal for low gradation and low resolution. In this case, in the first frame buffer 341, a first synthesized video signal obtained by synthesizing the first captured video signal for first luminance and high resolution and the first input video signal for high gradation and high resolution is stored. In the second frame buffer 342, a second synthesized video signal obtained by synthesizing the second captured video signal for second luminance and low resolution and the second input video signal for low gradation and low resolution is stored.

In the embodiments and modifications above, detection of the viewpoint position P10 and setting of the first image region and the second image region are performed for each generation of an image for one line, but may be performed for each generation of an image (frame image 20) for one frame.

In Modification 1 of Embodiment 1 above, the input processor 350 performs the process of thinning-out or mixing on the inputted first captured video signal for high resolution, to generate the second captured video signal for low resolution, as shown in FIG. 11. However, when a second captured video signal for low resolution is inputted from the camera 13, the input processor 350 may perform a complementation process on the inputted second captured video signal for low resolution, to generate a first captured video signal for high resolution. However, since the complementation process has a higher processing load than the thinning-out or mixing process, it is preferable that the video signal that is inputted to the input processor 350 is the first captured video signal for high resolution.

In Embodiments 2, 3 above, the first image region R31 and the second image region R32 are set based on the viewpoint position P10. However, not limited thereto, similar to Embodiment 1 shown in FIG. 7B, the first image region R1 and the second image region R2 may be set based on the viewpoint position P10. In Embodiments 2, 3 above, similar to Modification 3 of Embodiment 1 above, a plurality of regions R11 to R15 prepared in advance based on the viewpoint position P10 may be set.

In Embodiment 3 above, the input processors 350, 310 perform the process of reducing the number of gradations of the video signal to two gradations, but not limited thereto, may perform a process of reducing the number of gradations of the video signal to a number of gradations (e.g., 16 gradations) other than two.

In the embodiments and modifications above, two frame buffers, i.e., the first frame buffer 341 and the second frame buffer 342 are used. However, three or more frame buffers that store video signals having definitions (resolution, luminance, gradation, and combinations of these) different from each other may be used, to output the video signals to the line memory 221. In this case, two out of three or more frame buffers are selected as the first frame buffer 341 and the second frame buffer 342, and an image displaying process is performed. Which ones of the three or more frame buffers are to be used in generation of the image to be displayed is selected by the user, for example.

For example, when three frame buffers are used in the configuration as shown in FIG. 10, the three buffers that respectively temporarily store captured video signals having three levels of definition are provided between the input processor 350 and the signal synthesizer 330, and three buffers that respectively temporarily store input video signals having three levels of definition are provided between the input processor 310 and the signal synthesizer 330. Then, the signal synthesizer 330 synthesizes the captured video signals and the input video signals having definition levels corresponding to each other, and outputs synthesized video signals having three levels of definition having been synthesized, to corresponding frame buffers.

For example, when three frame buffers are used in Modification 1 of Embodiment 1, the signal synthesizer 330 synthesizes captured video signals having a high resolution, a medium resolution, and a low resolution with input video signals having a high resolution, a medium resolution, and a low resolution, respectively, and outputs synthesized video signals having three levels of definition having been synthesized, to corresponding frame buffers.

Similarly, also when three frame buffers are used in Embodiment 2 shown in FIG. 15, Embodiment 3 shown in FIG. 23, and the modification shown in FIG. 25, the signal synthesizer 330 generates synthesized video signals having three levels of definition, and outputs the synthesized video signals to corresponding frame buffers.

In addition, also when three frame buffers are used in the configuration in which synthesis of the captured video signal and the input video signal is not performed as shown in FIG. 12, the input processor 350 is placed in a subsequent stage of the camera 13, and three buffers that respectively temporarily store captured video signals having three levels of definition are provided in a subsequent stage of the input processor 350. Then, between the three buffers and the line memory 221, three frame buffers are respectively placed so as to correspond to the three buffers.

In the embodiments and modifications above, the range of the field of view of the camera 13 is the area in front of the AR glasses 1, but not limited thereto, may be the area above, below, or in the rear of the AR glasses 1.

In the embodiments and modifications above, two sets of the image generation device 3 and the mirror 4 are provided to the AR glasses 1 so as to correspond to the pair of eyes E of the user, but only one set may be provided to the AR glasses 1 so as to correspond to only one eye E of the user.

In the embodiments and modifications above, the light with which scanning is performed by the first scanner 140 and the second scanner 160 is guided to the eye E of the user via the mirror 4, but not limited thereto, may be guided to the eye E of the user via an optical system (e.g., lens, etc.) other than a mirror. The optical system in this case may be a combination of a plurality of mirrors, a combination of a mirror and a lens, or a combination of a plurality of lenses, for example.

In the embodiments and modifications above, the first mirror 141 and the second mirror 161 are separately provided, but instead of the first mirror 141 and the second mirror 161, one mirror that rotates about two axes may be provided.

Various modifications can be made as appropriate to the embodiments of the present invention without departing from the scope of the technological idea defined by the claims.

### (Additional Notes)

The following technologies are disclosed by the description of the embodiments above.

### (Technology 1)

An image generation device comprising:
an imaging processor including a camera configured to capture an image over a range of a field of view, the imaging processor being configured to output a first captured video signal for forming a frame image having a first definition and a second captured video signal for forming a frame image having a second definition different from the first definition;
a first frame buffer configured to store the first captured video signal;
a second frame buffer configured to store the second captured video signal;
a light source configured to emit light for forming the frame image;
a scanner configured to perform scanning with the light emitted from the light source;
a detector configured to detect a line of sight of a user; and
a controller, wherein
the controller
   controls the light source and the scanner such that, to a first image region including a viewpoint position on the frame image corresponding to the line of sight, the first captured video signal from the first frame buffer is applied, whereby an image is generated, and
   controls the light source and the scanner such that, to a second image region other than the first image region of the frame image, the second captured video signal from the second frame buffer is applied, whereby an image is generated.

According to this technology, the first captured video signal stored in the first frame buffer and the second captured video signal stored in the second frame buffer are selectively used in accordance with the line of sight of the user, whereby an image for one frame is generated. Therefore, the definition of the image can be smoothly switched between the first image region near the line of sight of the user and the other second image region.

### (Technology 2)

The image generation device according to technology 1, wherein
the first definition and the second definition are respectively a first resolution and a second resolution of the frame image defined according to a scanning speed of the scanner, and
the first resolution is higher than the second resolution.

According to this technology, in the first image region near the line of sight of the user, the frame image having a high resolution is displayed, and in the second image region in the periphery of the line of sight of the user, the frame image having a low resolution is displayed. Accordingly, the eyes of the user can be made less likely to become tired. In addition, even when the eyesight of the user is poor, the user can clearly grasp the subject or the scenery with reference to the frame image having the first resolution in the first image region.

### (Technology 3)

The image generation device according to technology 2, wherein
the camera
   outputs the first captured video signal corresponding to the first resolution, in a first imaging period in one frame period, and
   outputs the second captured video signal corresponding to the second resolution, in a second imaging period different from the first imaging period in one frame period.

According to this technology, video signals having the first resolution and the second resolution can be smoothly generated.

### (Technology 4)

The image generation device according to technology 2 or 3, wherein
the camera outputs the first captured video signal corresponding to the first resolution, and
the imaging processor comprises an input processor, the input processor being configured to perform thinning-out or mixing on the first captured video signal having the first resolution, to generate the second captured video signal corresponding to the second resolution.

According to this technology, since it is sufficient that the camera outputs the first captured video signal of one kind only, the configuration of and the process performed by the camera can be simplified. In the configuration in which two kinds of video signals are obtained in two different imaging periods, if the subject moves at a high speed, the positions of the subject become different from each other in the two kinds of video signals. However, according to the above configuration, since the camera outputs one kind of video signal only, even if the subject has moved at a high speed, the positions of the subject are the same with each other in the two kinds of video signals generated by the input processor. Therefore, discomfort for the user based on the first captured video signal and the second captured video signal can be avoided.

### (Technology 5)

The image generation device according to any one of technologies 1 to 4, wherein
the first definition and the second definition are respectively set according to a first exposure time and a second exposure time that are used when the camera performs capturing of an image.

According to this technology, when the subject of the camera is dark, if the first exposure time is set to be longer than the second exposure time, the frame image having a high luminance is displayed in the first image region near the line of sight of the user, and the frame image having a low luminance is displayed in the second image region in the periphery of the line of sight of the user. When the subject of the camera is bright, if the first exposure time is set to be shorter than the second exposure time, the frame image having a low luminance is displayed in the first image region near the line of sight of the user, and the frame image having a high luminance is displayed in the second image region in the periphery of the line of sight of the user. Accordingly, the user can view the subject of the camera at an appropriate luminance.

### (Technology 6)

The image generation device according to any one of technologies 1 to 5, wherein
the first definition and the second definition are a first gradation and a second gradation that define luminance resolution of the first captured video signal and the second captured video signal, respectively, and
the first gradation is higher than the second gradation.

According to this technology, the frame image having a high gradation is displayed in the first image region near the line of sight of the user, and the frame image having a low gradation is displayed in the second image region in the periphery of the line of sight of the user. Accordingly, the eyes of the user can be made less likely to become tired. In addition, even when the eyesight of the user is poor, the user can clearly grasp the subject with reference to the frame image having the first gradation in the first image region.

### (Technology 7)

The image generation device according to technology 6, wherein
the camera outputs the first captured video signal corresponding to the first gradation, and
the imaging processor comprises an input processor, the input processor being configured to perform a process of gradation lowering on the first captured video signal having the first gradation, to generate the second captured video signal corresponding to the second gradation.

According to this technology, video signals having the first gradation and the second gradation can be smoothly generated.

### (Technology 8)

The image generation device according to any one of technologies 1 to 7, comprising:
an input processor configured to output a first input video signal for forming a frame image having the first definition and a second input video signal for forming a frame image having the second definition, based on a video signal from an external device; and
a signal synthesizer configured to cause the first frame buffer to store a first synthesized video signal obtained by synthesizing the first captured video signal and the first input video signal, and configured to cause the second frame buffer to store a second synthesized video signal obtained by synthesizing the second captured video signal and the second input video signal, wherein
the controller
   controls the light source and the scanner such that, to the first image region, the first synthesized video signal from the first frame buffer is applied, whereby an image is generated, and
   controls the light source and the scanner such that, to the second image region, the second synthesized video signal from the second frame buffer is applied, whereby an image is generated.

According to this technology, the frame image can be generated by synthesizing the video signal from the imaging processor and the video signal from the external device. In this case as well, the first synthesized video signal stored in the first frame buffer and the second synthesized video signal stored in the second frame buffer are selectively used in accordance with the line of sight of the user, whereby an image for one frame is generated. Therefore, the definition of the image can be smoothly switched between the first image region near the line of sight of the user and the other second image region.

### (Technology 9)

A head-mounted display comprising:
the image generation device according to any one of technologies 1 to 8;
a frame configured to hold the image generation device; and
an optical system configured to guide light from the image generation device, to an eye of the user wearing the head-mounted display on a head of the user.

According to this technology, by wearing the head-mounted display on the head, the user can grasp the scenery, etc. of which an image has been captured by the camera, through the frame image generated by the image generation device.

What is claimed is:

1. An image generation device comprising:
an imaging processor including a camera configured to capture an image over a range of a field of view, the imaging processor being configured to output a first captured video signal for forming a frame image having a first definition and a second captured video signal for forming a frame image having a second definition different from the first definition;
a first frame buffer configured to store the first captured video signal;
a second frame buffer configured to store the second captured video signal;
a light source configured to emit light for forming the frame image;
a scanner configured to perform scanning with the light emitted from the light source;
a detector configured to detect a line of sight of a user; and
a controller configured to
control the light source and the scanner such that, to a first image region including a viewpoint position on the frame image corresponding to the line of sight, the first captured video signal from the first frame buffer is applied, whereby an image is generated, and
control the light source and the scanner such that, to a second image region other than the first image region of the frame image, the second captured video signal from the second frame buffer is applied, whereby an image is generated.

2. The image generation device according to claim 1, wherein
the first definition and the second definition are respectively a first resolution and a second resolution of the frame image defined according to a scanning speed of the scanner, and
the first resolution is higher than the second resolution.

3. The image generation device according to claim 2, wherein
the camera
outputs the first captured video signal corresponding to the first resolution, in a first imaging period in one frame period, and
outputs the second captured video signal corresponding to the second resolution, in a second imaging period different from the first imaging period in one frame period.

4. The image generation device according to claim 2, wherein
the camera outputs the first captured video signal corresponding to the first resolution, and
the imaging processor comprises an input processor, the input processor being configured to perform thinning-out or mixing on the first captured video signal having the first resolution, to generate the second captured video signal corresponding to the second resolution.

5. The image generation device according to claim 1, wherein
the first definition and the second definition are respectively set according to a first exposure time and a second exposure time that are used when the camera performs capturing of an image.

6. The image generation device according to claim 1, wherein
the first definition and the second definition are a first gradation and a second gradation that define luminance resolution of the first captured video signal and the second captured video signal, respectively, and
the first gradation is higher than the second gradation.

7. The image generation device according to claim 6, wherein
the camera outputs the first captured video signal corresponding to the first gradation, and
the imaging processor comprises an input processor, the input processor being configured to perform a process of gradation lowering on the first captured video signal having the first gradation, to generate the second captured video signal corresponding to the second gradation.

8. The image generation device according to claim 1, comprising:
an input processor configured to output a first input video signal for forming a frame image having the first definition and a second input video signal for forming a frame image having the second definition, based on a video signal from an external device; and
a signal synthesizer configured to cause the first frame buffer to store a first synthesized video signal obtained by synthesizing the first captured video signal and the first input video signal, and configured to cause the second frame buffer to store a second synthesized video signal obtained by synthesizing the second captured video signal and the second input video signal, wherein
the controller
controls the light source and the scanner such that, to the first image region, the first synthesized video signal from the first frame buffer is applied, whereby an image is generated, and
controls the light source and the scanner such that, to the second image region, the second synthesized video signal from the second frame buffer is applied, whereby an image is generated.

9. A head-mounted display comprising:
an image generation device configured to generate an image by performing scanning with light;
a frame configured to hold the image generation device; and
an optical system configured to guide the light with which scanning is performed by the image generation device, to an eye of a user wearing the head-mounted display on a head of the user, wherein
the image generation device comprises
an imaging processor including a camera configured to capture an image over a range of a field of view, the imaging processor being configured to output a first captured video signal for forming a frame image having a first definition and a second captured video signal for forming a frame image having a second definition different from the first definition,
a first frame buffer configured to store the first captured video signal,
a second frame buffer configured to store the second captured video signal,
a light source configured to emit light for forming the frame image,
a scanner configured to perform scanning with the light emitted from the light source,
a detector configured to detect a line of sight of the user, and
a controller configured to
control the light source and the scanner such that, to a first image region including a viewpoint position on the frame image corresponding to the line of sight, the first captured video signal from the first frame buffer is applied, whereby an image is generated, and
control the light source and the scanner such that, to a second image region other than the first image region of the frame image, the second captured video signal from the second frame buffer is applied, whereby an image is generated.

10. The head-mounted display according to claim 9, wherein
the first definition and the second definition are respectively a first resolution and a second resolution of the frame image defined according to a scanning speed of the scanner, and
the first resolution is higher than the second resolution.

11. The head-mounted display according to claim 10, wherein
the camera
outputs the first captured video signal corresponding to the first resolution, in a first imaging period in one frame period, and
outputs the second captured video signal corresponding to the second resolution, in a second imaging period different from the first imaging period in one frame period.

12. The head-mounted display according to claim 10, wherein
the camera outputs the first captured video signal corresponding to the first resolution, and
the imaging processor comprises an input processor, the input processor being configured to perform thinning-out or mixing on the first captured video signal having the first resolution, to generate the second captured video signal corresponding to the second resolution.

13. The head-mounted display according to claim 9, wherein
the first definition and the second definition are respectively set according to a first exposure time and a second exposure time that are used when the camera performs capturing of an image.

14. The head-mounted display according to claim 9, wherein
the first definition and the second definition are a first gradation and a second gradation that define luminance resolution of the first captured video signal and the second captured video signal, respectively, and
the first gradation is higher than the second gradation.

15. The head-mounted display according to claim 14, wherein
the camera outputs the first captured video signal corresponding to the first gradation, and
the imaging processor comprises an input processor, the input processor being configured to perform a process of gradation lowering on the first captured video signal having the first gradation, to generate the second captured video signal corresponding to the second gradation.

16. The head-mounted display according to claim 9, comprising:
an input processor configured to output a first input video signal for forming a frame image having the first definition and a second input video signal for forming a frame image having the second definition, based on a video signal from an external device; and
a signal synthesizer configured to cause the first frame buffer to store a first synthesized video signal obtained by synthesizing the first captured video signal and the first input video signal, and configured to cause the second frame buffer to store a second synthesized video signal obtained by synthesizing the second captured video signal and the second input video signal, wherein
the controller
controls the light source and the scanner such that, to the first image region, the first synthesized video signal from the first frame buffer is applied, whereby an image is generated, and
controls the light source and the scanner such that, to the second image region, the second synthesized video signal from the second frame buffer is applied, whereby an image is generated.
